(19) United States
(12) Patent Application Publication
(10) Pub. No.: US 2021/0307022 A1
(43) Pub. Date: Sep. 30, 2021

(54) SELECTIVE DETECTION OF FEEDBACK FOR RESOURCE SELECTION

(71) Applicant: QUALCOMM Incorporated, San Diego, CA (US)

(72) Inventors: Tien Viet NGUYEN, Bridgewater, NJ (US); Gabi SARKIS, San Diego, CA (US); Sudhir Kumar BAGHEL, Hillsborough, NJ (US); Kapil GULATI, Belle Mead, NJ (US)

(21) Appl. No.: 17/210,246

(22) Filed: Mar. 23, 2021

Related U.S. Application Data
(60) Provisional application No. 62/994,154, filed on Mar. 24, 2020.

(51) Int. Cl. H04W 72/08; H04W 24/08; H04B 17/318; H04W 72/04

(52) U.S. Cl. CPC H04W 72/085; H04W 72/0406; H04B 17/318; H04W 24/08

(57) ABSTRACT

Aspects relate to resource selection by a first device within a wireless communication network. A second device may reserve resources for a first transmission and a retransmission to at least one third device over a direct link. If the strength of a signal received from the second device is greater than a threshold, the first device may detect feedback from the at least one third device to determine whether there will be a retransmission. If there will not be a retransmission, the first device may add to a candidate set at least one resource that overlaps with at least one of the resources previously reserved for the retransmission. If the signal strength is less than a threshold, the first device may, without detecting the feedback, add to a candidate set of resources at least one resource that overlaps with at least one of the resources previously reserved for the retransmission.

### CROSS-REFERENCE TO RELATED APPLICATIONS

The present application for patent claims priority to and the benefit of pending U.S. Provisional Application No. 62/994,154, titled “SELECTIVE DETECTION OF FEEDBACK FOR RESOURCE SELECTION,” filed Mar. 24, 2020, and assigned to the assignee hereof and hereby expressly incorporated by reference herein as if fully set forth below in its entirety and for all applicable purposes.

### TECHNICAL FIELD

The technology discussed below relates generally to wireless communication and, more particularly, to resource selection involving selective detection of feedback.

### INTRODUCTION

In many existing wireless communication systems, a cellular network is implemented by enabling wireless communication devices to communicate with one another through signaling with a nearby base station or cell. As a wireless communication device moves across the service area, handovers take place such that each wireless communication device maintains communication with one another via its respective cell.

Another scheme for a wireless communication system is a device to device (D2D) network, in which wireless communication devices may signal one another directly, rather than via an intermediary base station or cell. D2D communication networks may utilize direct signaling (e.g., sidelink signaling) to facilitate direct communication between wireless communication devices over a proximity service (ProSe) PC5 interface. In some D2D configurations, wireless communication devices may further communicate in a cellular system, generally under the control of a base station. Thus, the wireless communication devices may be configured for uplink and downlink signaling via a base station and further for sidelink signaling directly between the wireless communication devices without transmissions passing through the base station.

One example of a sidelink wireless communication system is a vehicle-to-everything (V2X) communication system. V2X communication involves the exchange of information not only between vehicles themselves, but also between vehicles and external systems, such as streetlights, buildings, pedestrians, and wireless communication networks. V2X systems enable vehicles to obtain information related to the weather, nearby accidents, road conditions, activities of nearby vehicles and pedestrians, objects nearby the vehicle, and other pertinent information that may be utilized to improve the vehicle driving experience, increase vehicle safety, and support autonomous vehicles.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In some examples, a method for wireless communication at a first wireless communication device is disclosed. The method may include receiving a signal from a second wireless communication device and measuring a signal strength of the signal. The method may also include receiving control information indicating that the second wireless communication device reserved a first resource of a plurality of resources for a first transmission to at least one third wireless communication device and at least one second resource of the plurality of resources for at least one retransmission to the at least one third wireless communication device. In addition, the method may include decoding feedback associated with the first transmission when the signal strength is greater than a threshold or abstaining from detecting the feedback when the signal strength is less than the threshold.

In some examples, a first wireless communication device may include a transceiver, a memory, and a processor communicatively coupled to the transceiver and the memory. The processor and the memory may be configured to receive a signal from a second wireless communication device via the transceiver and measure a signal strength of the signal. The processor and the memory may also be configured to receive control information indicating that the second wireless communication device reserved a first resource of a plurality of resources for a first transmission to at least one third wireless communication device and at least one second resource of the plurality of resources for at least one retransmission to the at least one third wireless communication device. In addition, the processor and the memory may be configured to decode feedback associated with the first transmission when the signal strength is greater than a threshold or abstain from detecting the feedback when the signal strength is less than the threshold.

In some examples, a first wireless communication device may include means for receiving a signal from a second wireless communication device and means for measuring a signal strength of the signal. The means for receiving may be configured to receive control information indicating that the second wireless communication device reserved a first resource of a plurality of resources for a first transmission to at least one third wireless communication device and at least one second resource of the plurality of resources for at least one retransmission to the at least one third wireless communication device. The apparatus may also include means for decoding feedback associated with the first transmission when the signal strength is greater than a threshold or abstaining from detecting the feedback when the signal strength is less than the threshold.

In some examples, an article of manufacture for use by a first wireless communication device includes a non-transitory computer-readable medium having stored therein instructions executable by one or more processors of the first wireless communication device to receive a signal from a second wireless communication device and measure a signal strength of the signal. The computer-readable medium may also have stored therein instructions executable by one or more processors of the first wireless communication device to receive control information indicating that the second wireless communication device reserved a first resource of a plurality of resources for a first transmission to at least one third wireless communication device and at least one second resource of the plurality of resources for a retransmission to the at least one third wireless communication device. In addition, the computer-readable medium may have stored therein instructions executable by one or more processors of the first wireless communication device to decode feedback associated with the first transmission when the signal strength is greater than a threshold or abstain from detecting the feedback when the signal strength is less than the threshold.

These and other aspects of the disclosure will become more fully understood upon a review of the detailed description, which follows. Other aspects, features, and examples of the present disclosure will become apparent to those of ordinary skill in the art, upon reviewing the following description of specific, example aspects of the present disclosure in conjunction with the accompanying figures. While features of the present disclosure may be discussed relative to certain examples and figures below, all examples of the present disclosure can include one or more of the advantageous features discussed herein. In other words, while one or more examples may be discussed as having certain advantageous features, one or more of such features may also be used in accordance with the various examples of the disclosure discussed herein. In similar fashion, while example aspects may be discussed below as device, system, or method examples it should be understood that such example aspects can be implemented in various devices, systems, and methods.

### BRIEF DESCRIPTION OF THE DRAWINGS

FIG. 1 is a diagram illustrating an example of a wireless radio access network according to some aspects.

FIG. 2 is a schematic diagram illustrating organization of wireless resources in an air interface utilizing orthogonal frequency divisional multiplexing (OFDM) according to some aspects.

FIG. 3 is a diagram illustrating an example of a wireless communication network employing sidelink communication according to some aspects.

FIG. 4A is a conceptual diagram illustrating an example of a sidelink slot structure according to some aspects.

FIG. 4B is a conceptual diagram illustrating another example of a sidelink slot structure according to some aspects.

FIG. 5 is a conceptual diagram illustrating an example of a sidelink slot structure with feedback resources according to some aspects.

FIG. 6 is a diagram illustrating an example of a resource allocation according to some aspects.

FIG. 7 is a diagram illustrating an example of a group that may be formed in a direct wireless communication system according to some aspects.

FIG. 8 is a signaling diagram illustrating an example of signaling for a first type of feedback-based retransmission within a direct wireless communication system according to some aspects.

FIG. 9 is a signaling diagram illustrating an example of signaling for a second type of feedback-based retransmission within a direct wireless communication system according to some aspects.

FIG. 10 is a flow chart of an example method for a user equipment (UE) to reserve a resource within a direct wireless communication system according to some aspects.

FIG. 11 is a block diagram illustrating an example of a hardware implementation for a wireless communication device employing a processing system according to some aspects.

FIG. 12 is a flow chart of an example method for a wireless communication device according to some aspects.

FIG. 13 is a flow chart of an example method for a wireless communication device to reserve a resource within a direct wireless communication system according to some aspects.

FIG. 14 is a flow chart of an example method for a wireless communication device to reserve a resource without detecting feedback within a direct wireless communication system according to some aspects.

FIG. 15 is a flow chart of an example method for a wireless communication device to reserve a resource including detecting feedback within a direct wireless communication system according to some aspects.

FIG. 16 is a flow chart of an example method for a wireless communication device to transmit a packet on a selected resource according to some aspects.

FIG. 17 is a flow chart of an example method for a wireless communication device to determine whether to transmit a retransmission according to some aspects.

FIG. 18 is a flow chart of another example method for a wireless communication device to determine whether to transmit a retransmission according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, artificial intelligence-enabled (AI-enabled) devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

Various aspects of the disclosure relate to mechanisms for resource reservation by a first wireless communication device within a direct (e.g., sidelink) wireless communication network, such as a vehicle-to-everything (V2X) network. In such a network, a second wireless communication device may reserve resources for a first transmission and at least one retransmission to at least one third wireless communication device over a direct link. The first wireless communication device may measure the strength of a signal received from the second wireless communication device.

In some examples, if the signal strength is greater than a threshold, the first wireless communication device may monitor feedback from the at least one third wireless communication device to determine whether there will be a retransmission by the second wireless communication device. If there will not be a retransmission, the first wireless communication device may use at least one resource that overlaps with (i.e., at least partially overlaps with) the resources previously reserved by the second wireless communication device for the at least one retransmission. For example, the first wireless communication device may include in a candidate set one or more of the resources that overlap with the resources that the second wireless communication device will not be using since there is no retransmission. The first wireless communication device may subsequently select (e.g., randomly select) one or more resources from the candidate set to transmit a packet.

In some examples, if the signal strength is less than a threshold, the first wireless communication device may use at least one resource that overlaps with the resources previously reserved for the at least one retransmission by the second wireless communication device without first detecting (e.g., monitoring for) the feedback. For example, the first wireless communication device may include in a candidate set one or more of the resources overlapping with the resources reserved by the second wireless communication device for the at least one retransmission. The first wireless communication device may subsequently select (e.g., randomly select) one or more resources from the candidate set to transmit a packet.

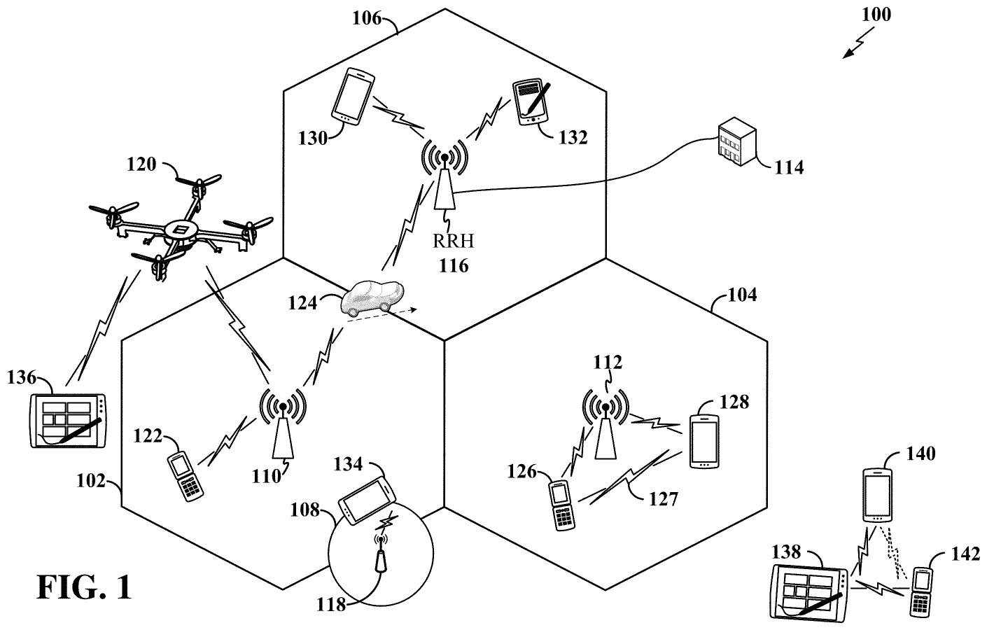

The various concepts presented throughout this disclosure may be implemented across a broad variety of telecommunication systems, network architectures, and communication standards. Referring now to FIG. 1, as an illustrative example without limitation, a schematic illustration of a radio access network (RAN) 100 is provided. The RAN 100 may implement any suitable wireless communication technology or technologies to provide radio access. As one example, the RAN 100 may operate according to 3^{rd} Generation Partnership Project (3GPP) New Radio (NR) specifications, often referred to as 5G. As another example, the RAN 100 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

The geographic region covered by the radio access network 100 may be divided into a number of cellular regions (cells) that can be uniquely identified by a user equipment (UE) based on an identification broadcasted over a geographical area from one access point or base station. FIG. 1 illustrates cells 102, 104, 106, and cell 108, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

In general, a respective base station (BS) serves each cell. Broadly, a base station is a network element in a radio access network responsible for radio transmission and reception in one or more cells to or from a UE. A BS may also be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 100 operates according to both the LTE and 5G NR standards, one of the base stations may be an LTE base station, while another base station may be a 5G NR base station.

Various base station arrangements can be utilized. For example, in FIG. 1, two base stations 110 and 112 are shown in cells 102 and 104; and a third base station 114 is shown controlling a remote radio head (RRH) 116 in cell 106. That is, a base station can have an integrated antenna or can be connected to an antenna or RRH by feeder cables. In the illustrated example, the cells 102, 104, and 106 may be referred to as macrocells, as the base stations 110, 112, and 114 support cells having a large size. Further, a base station 118 is shown in the cell 108 which may overlap with one or more macrocells. In this example, the cell 108 may be referred to as a small cell (e.g., a microcell, picocell, femtocell, home base station, home Node B, home eNode B, etc.), as the base station 118 supports a cell having a relatively small size. Cell sizing can be done according to system design as well as component constraints.

It is to be understood that the radio access network 100 may include any number of wireless base stations and cells. Further, a relay node may be deployed to extend the size or coverage area of a given cell. The base stations 110, 112, 114, 118 provide wireless access points to a core network for any number of mobile apparatuses.

FIG. 1 further includes an unmanned aerial vehicle (UAV) 120, which may be a drone or quadcopter. The UAV 120 may be configured to function as a base station, or more specifically as a mobile base station. That is, in some examples, a cell may not necessarily be stationary, and the geographic area of the cell may move according to the location of a mobile base station such as the UAV 120.

In general, base stations may include a backhaul interface for communication with a backhaul portion (not shown) of the network. The backhaul may provide a link between a base station and a core network (not shown), and in some examples, the backhaul may provide interconnection between the respective base stations. The core network may be a part of a wireless communication system and may be independent of the radio access technology used in the radio access network. Various types of backhaul interfaces may be employed, such as a direct physical connection, a virtual network, or the like using any suitable transport network.

The RAN 100 is illustrated supporting wireless communication for multiple mobile apparatuses. A mobile apparatus is commonly referred to as user equipment (UE) in standards and specifications promulgated by the 3rd Generation Partnership Project (3GPP), but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Within the RAN 100, the cells may include UEs that may be in communication with one or more sectors of each cell. For example, UEs 122 and 124 may be in communication with base station 110; UEs 126 and 128 may be in communication with base station 112; UEs 130 and 132 may be in communication with base station 114 by way of RRH 116; UE 134 may be in communication with base station 118; and UE 136 may be in communication with mobile base station (e.g., the UAV 120). Here, each base station 110, 112, 114, 118, and 120 may be configured to provide an access point to a core network (not shown) for all the UEs in the respective cells. In some examples, the UAV 120 (e.g., the quadcopter) can be a mobile network node and may be configured to function as a UE. For example, the UAV 120 may operate within cell 102 by communicating with base station 110.

Wireless communication between a RAN 100 and a UE (e.g., UE 122 or 124) may be described as utilizing an air interface. Transmissions over the air interface from a base station (e.g., base station 110) to one or more UEs (e.g., UE 122 and 124) may be referred to as downlink (DL) transmission. In accordance with certain aspects of the present disclosure, the term downlink may refer to a point-to-multipoint transmission originating at a scheduling entity (described further below; e.g., base station 110). Another way to describe this scheme may be to use the term broadcast channel multiplexing. Transmissions from a UE (e.g., UE 122) to a base station (e.g., base station 110) may be referred to as uplink (UL) transmissions. In accordance with further aspects of the present disclosure, the term uplink may refer to a point-to-point transmission originating at a scheduled entity (described further below; e.g., UE 122).

For example, DL transmissions may include unicast or broadcast transmissions of control information and/or traffic information (e.g., user data traffic) from a base station (e.g., base station 110) to one or more UEs (e.g., UEs 122 and 124), while UL transmissions may include transmissions of control information and/or traffic information originating at a UE (e.g., UE 122). In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 milliseconds (ms)) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In some examples, access to the air interface may be scheduled, wherein a scheduling entity (e.g., a base station) allocates resources (e.g., time-frequency resources) for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs or scheduled entities utilize resources allocated by the scheduling entity.

Base stations are not the only entities that may function as a scheduling entity. That is, in some examples, a UE may function as a scheduling entity, scheduling resources for one or more scheduled entities (e.g., one or more other UEs). For example, two or more UEs (e.g., UEs 138, 140, and 142) may communicate with each other using sidelink signals 137 without relaying that communication through a base station. In some examples, the UEs 138, 140, and 142 may each function as a scheduling entity or transmitting sidelink device and/or a scheduled entity or a receiving sidelink device to schedule resources and communicate sidelink signals 137 therebetween without relying on scheduling or control information from a base station. In other examples, two or more UEs (e.g., UEs 126 and 128) within the coverage area of a base station (e.g., base station 112) may also communicate sidelink signals 127 over a direct link (sidelink) without conveying that communication through the base station 112. In this example, the base station 112 may allocate resources to the UEs 126 and 128 for the sidelink communication. In either case, such sidelink signaling 127 and 137 may be implemented in a peer-to-peer (P2P) network, a device-to-device (D2D) network, a vehicle-to-vehicle (V2V) network, a vehicle-to-everything (V2X) network, a mesh network, or other suitable direct link network.

In some examples, a D2D relay framework may be included within a cellular network to facilitate relaying of communication to/from the base station 112 via D2D links (e.g., sidelinks 127 or 137). For example, one or more UEs (e.g., UE 128) within the coverage area of the base station 112 may operate as relaying UEs to extend the coverage of the base station 112, improve the transmission reliability to one or more UEs (e.g., UE 126), and/or to allow the base station to recover from a failed UE link due to, for example, blockage or fading.

Two primary technologies that may be used by V2X networks include dedicated short range communication (DSRC) based on Institute of Electrical and Electronics Engineers (IEEE) 802.11p standards and cellular V2X based on LTE and/or 5G (New Radio) standards. Various aspects of the present disclosure may relate to New Radio (NR) cellular V2X networks, referred to herein as V2X networks, for simplicity. However, it should be understood that the concepts disclosed herein may not be limited to a particular V2X standard or may be directed to sidelink networks other than V2X networks.

In order for transmissions over the air interface to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

Data coding may be implemented in multiple manners. In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

Aspects of the present disclosure may be implemented utilizing any suitable channel code. Various implementations of base stations and UEs may include suitable hardware and capabilities (e.g., an encoder, a decoder, and/or a CODEC) to utilize one or more of these channel codes for wireless communication.

In the RAN 100, the ability for a UE to communicate while moving, independent of their location, is referred to as mobility. The various physical channels between the UE and the RAN are generally set up, maintained, and released under the control of an access and mobility management function (AMF). In some scenarios, the AMF may include a security context management function (SCMF) and a security anchor function (SEAF) that performs authentication. The SCMF can manage, in whole or in part, the security context for both the control plane and the user plane functionality.

In some examples, a RAN 100 may enable mobility and handovers (i.e., the transfer of a UE's connection from one radio channel to another). For example, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 124 may move from the geographic area corresponding to its serving cell 102 to the geographic area corresponding to a neighbor cell 106. When the signal strength or quality from the neighbor cell 106 exceeds that of its serving cell 102 for a given amount of time, the UE 124 may transmit a reporting message to its serving base station 110 indicating this condition. In response, the UE 124 may receive a handover command, and the UE may undergo a handover to the cell 106.

In various implementations, the air interface in the RAN 100 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The air interface in the RAN 100 may utilize one or more multiplexing and multiple access algorithms to enable simultaneous communication of the various devices. For example, 5G NR specifications provide multiple access for UL or reverse link transmissions from UEs 122 and 124 to base station 110, and for multiplexing DL or forward link transmissions from the base station 110 to UEs 122 and 124 utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 110 to UEs 122 and 124 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Further, the air interface in the RAN 100 may utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex.

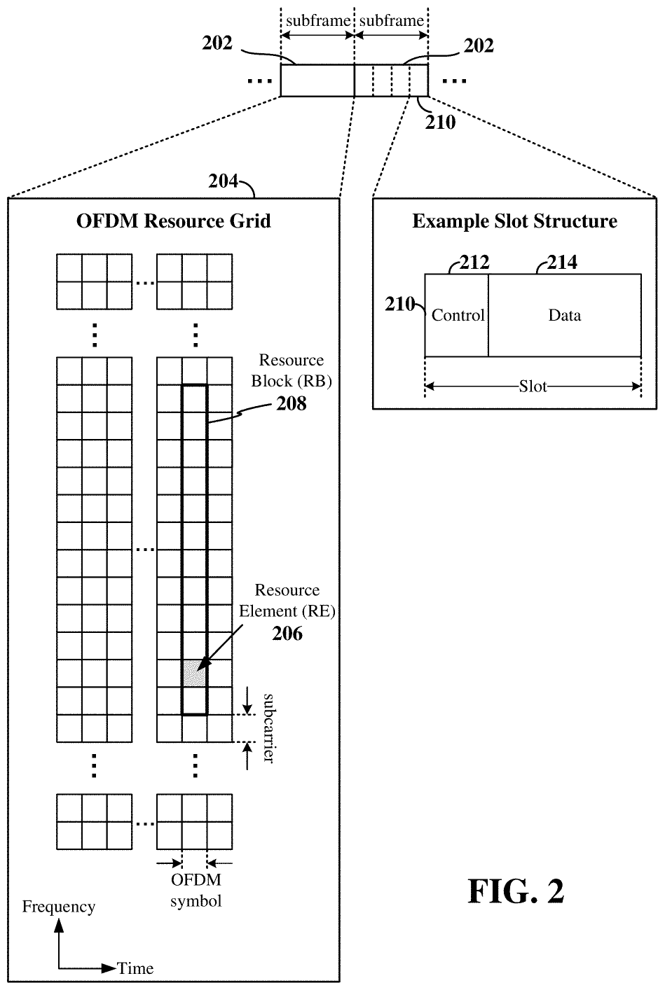

Various aspects of the present disclosure will be described with reference to an OFDM waveform, schematically illustrated in FIG. 2. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 2, an expanded view of an example subframe 202 is illustrated, showing an OFDM resource grid. However, as those skilled in the art will readily appreciate, the physical layer (PHY layer) transmission structure for any particular application may vary from the example described here, depending on any number of factors. Here, time is in the horizontal direction with units of OFDM symbols; and frequency is in the vertical direction with units of subcarriers of the carrier.

The resource grid 204 may be used to schematically represent time-frequency resources for a given antenna port. That is, in a multiple-input-multiple-output (MIMO) implementation with multiple antenna ports available, a corresponding multiple number of resource grids 204 may be available for communication. The resource grid 204 is divided into multiple resource elements (REs) 206. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 208, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 208 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of UEs or sidelink devices (hereinafter collectively referred to as UEs) for downlink, uplink, or sidelink transmissions typically involves scheduling one or more resource elements 206 within one or more sub-bands or bandwidth parts (BWPs). Thus, a UE generally utilizes only a subset of the resource grid 204. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a base station (e.g., gNB, eNB, etc.) or may be self-scheduled by a UE/sidelink device implementing D2D sidelink communication.

In this illustration, the RB 208 is shown as occupying less than the entire bandwidth of the subframe 202, with some subcarriers illustrated above and below the RB 208. In a given implementation, the subframe 202 may have a bandwidth corresponding to any number of one or more RBs 208. Further, in this illustration, the RB 208 is shown as occupying less than the entire duration of the subframe 202, although this is merely one possible example.

Each 1 ms subframe 202 may consist of one or multiple adjacent slots. In the example shown in FIG. 2, one subframe 202 includes four slots 210, as an illustrative example. In some examples, a slot may be defined according to a specified number of OFDM symbols with a given cyclic prefix (CP) length. For example, a slot may include 7 or 12 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 210 illustrates the slot 210 including a control region 212 and a data region 214. In general, the control region 212 may carry control channels, and the data region 214 may carry data channels. Of course, a slot may contain all DL, all UL, or at least one DL portion and at least one UL portion. The structure illustrated in FIG. 2 is merely an example, and different slot structures may be utilized, and may include one or more of each of the control region(s) and data region(s).

Although not illustrated in FIG. 2, the various REs 206 within an RB 208 may be scheduled to carry one or more physical channels, including control channels, shared channels, data channels, etc. Other REs 206 within the RB 208 may also carry pilots or reference signals. These pilots or reference signals may provide for a receiving device to perform channel estimation of the corresponding channel, which may enable coherent demodulation/detection of the control and/or data channels within the RB 208.

In some examples, the slot 210 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 206 (e.g., within the control region 212) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 206 (e.g., in the control region 212 or the data region 214) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 20, 80, or 120 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information.

In an UL transmission, the scheduled entity (e.g., UE) may utilize one or more REs 206 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 206 (e.g., within the data region 214) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 206 within the data region 214 may be configured to carry other signals, such as one or more SIBs and DMRSs.

In an example of sidelink communication over a sidelink carrier via a PC5 interface, the control region 212 of the slot 210 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 214 of the slot 210 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 206 within slot 210. For example, HARQ feedback information may be transmitted in a physical sidelink feedback channel (PSFCH) within the slot 210 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 210.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIG. 2 are not necessarily all of the channels or carriers that may be utilized between devices, and those of ordinary skill in the art will recognize that other channels or carriers may be utilized in addition to those illustrated, such as other traffic, control, and feedback channels.

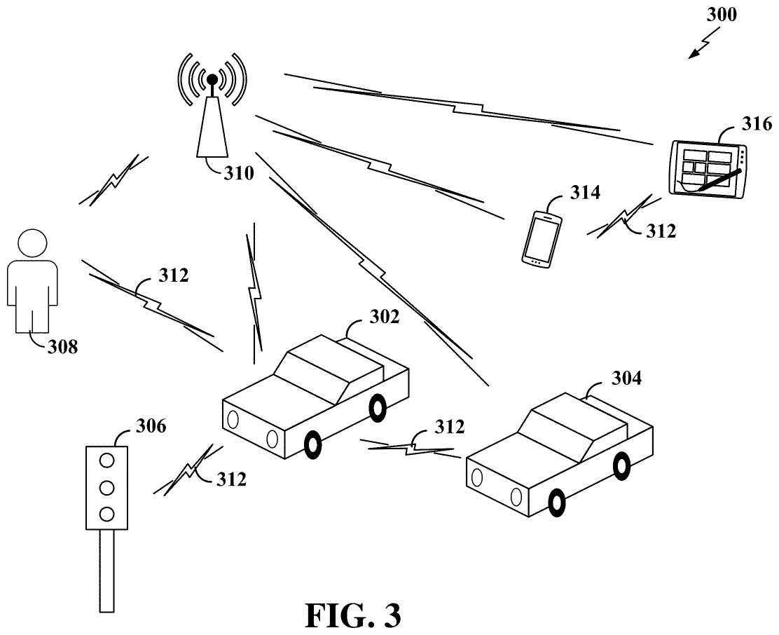

FIG. 3 illustrates an example of a wireless communication network 300 configured to support D2D or sidelink communication. In some examples, sidelink communication may include V2X communication. V2X communication involves the wireless exchange of information directly between not only vehicles (e.g., vehicles 302 and 304) themselves, but also directly between vehicles 302/304 and infrastructure (e.g., roadside units (RSUs) 306), such as streetlights, buildings, traffic cameras, tollbooths or other stationary objects, vehicles 302/304 and pedestrians 308, and vehicles 302/304 and wireless communication networks (e.g., base station 310). In some examples, V2X communication may be implemented in accordance with the New Radio (NR) cellular V2X standard defined by 3GPP, Release 16, or other suitable standard.

V2X communication enables vehicles 302 and 304 to obtain information related to the weather, nearby accidents, road conditions, activities of nearby vehicles and pedestrians, objects nearby the vehicle, and other pertinent information that may be utilized to improve the vehicle driving experience and increase vehicle safety. For example, such V2X data may enable autonomous driving and improve road safety and traffic efficiency. For example, the exchanged V2X data may be utilized by a V2X connected vehicle 302 and 304 to provide in-vehicle collision warnings, road hazard warnings, approaching emergency vehicle warnings, pre-/post-crash warnings and information, emergency brake warnings, traffic jam ahead warnings, lane change warnings, intelligent navigation services, and other similar information. In addition, V2X data received by a V2X connected mobile device of a pedestrian/cyclist 308 may be utilized to trigger a warning sound, vibration, flashing light, etc., in case of imminent danger.

V2X transmissions may include, for example, unicast transmissions, groupcast transmissions, and broadcast transmissions. A unicast transmission may include, for example, a transmission from a vehicle (e.g., vehicle 302) to one other vehicle (e.g., vehicle 304). A groupcast transmission may include, for example, a transmission when group of UEs (e.g., vehicles 302 and 304) form a cluster. In this case, data may be groupcasted within the cluster. A broadcast transmission may include, for example, a transmission from a UE (e.g., vehicle 302) to surrounding receivers (e.g., vehicle 304, a roadside unit (RSU) 306, mobile devices 308 of pedestrians/cyclists, the network (e.g., base station 310), or any combination thereof) in proximity to the transmitting UE.

The sidelink communication between vehicle-UEs (V-UEs) 302 and 304 or between a V-UE 302 or 304 and either an RSU 306 or a pedestrian-UE (P-UE) 308 may occur over a sidelink 312 utilizing a proximity service (ProSe) PC5 interface. In various aspects of the disclosure, the PC5 interface may further be utilized to support D2D sidelink 312 communication in other proximity use cases (e.g., other than V2X). Examples of other proximity use cases may include public safety or commercial (e.g., entertainment, education, office, medical, and/or interactive) based proximity services. In the example shown in FIG. 3, ProSe communication may further occur between UEs 314 and 316.

ProSe communication may support different operational scenarios, such as in-coverage, out-of-coverage, and partial coverage. Out-of-coverage refers to a scenario in which UEs (e.g., UEs 314 and 316) are outside of the coverage area of a base station (e.g., base station 310), but each are still configured for ProSe communication. Partial coverage refers to a scenario in which some of the UEs (e.g., V-UE 304) are outside of the coverage area of the base station 310, while other UEs (e.g., V-UE 302 and P-UE 308) are in communication with the base station 310. In-coverage refers to a scenario in which UEs (e.g., V-UE 302 and P-UE 308) are in communication with the base station 310 (e.g., gNB) via a Uu (e.g., cellular interface) connection to receive ProSe service authorization and provisioning information to support ProSe operations.

To facilitate D2D sidelink communication between, for example, UEs 314 and 316 over the sidelink 312, the UEs 314 and 316 may transmit discovery signals therebetween. In some examples, each discovery signal may include a synchronization signal, such as a primary synchronization signal (PSS) and/or a secondary synchronization signal (SSS) that facilitates device discovery and enables synchronization of communication on the sidelink 312. For example, the discovery signal may be utilized by the UE 316 to measure the signal strength and channel status of a potential sidelink (e.g., sidelink 312) with another UE (e.g., UE 314). The UE 316 may utilize the measurement results to select a UE (e.g., UE 314) for sidelink communication or relay communication.

In 5G NR sidelink, sidelink communication may utilize transmission or reception resource pools. For example, the minimum resource allocation unit in frequency may be a sub-channel (e.g., which may include, for example, 10, 15, 20, 25, 50, 75, or 100 consecutive resource blocks) and the minimum resource allocation unit in time may be one slot. A radio resource control (RRC) configuration of the resource pools may be either pre-configured (e.g., a factory setting on the UE determined, for example, by sidelink standards or specifications) or configured by a base station (e.g., base station 310).

In addition, there may be two main resource allocation modes of operation for sidelink (e.g., PC5) communications. In a first mode, Mode 1, a base station (e.g., gNB) 310 may allocate resources to sidelink devices (e.g., V2X devices or other sidelink devices) for sidelink communication between the sidelink devices in various manners. For example, the base station 310 may allocate sidelink resources dynamically (e.g., a dynamic grant) to sidelink devices, in response to requests for sidelink resources from the sidelink devices. The base station 310 may further activate preconfigured sidelink grants (e.g., configured grants) for sidelink communication among the sidelink devices. In Mode 1, sidelink feedback may be reported back to the base station 310 by a transmitting sidelink device.

In a second mode, Mode 2, the sidelink devices may autonomously select sidelink resources for sidelink communication therebetween. In some examples, a transmitting sidelink device may perform resource/channel sensing to select resources (e.g., sub-channels) on the sidelink channel that are unoccupied. Signaling on the sidelink is the same between the two modes. Therefore, from a receiver's point of view, there is no difference between the modes.

In some examples, sidelink (e.g., PC5) communication may be scheduled by use of sidelink control information (SCI). SCI may include two SCI stages. Stage 1 sidelink control information (first stage SCI) may be referred to herein as SCI-1. Stage 2 sidelink control information (second stage SCI) may be referred to herein as SCI-2.

SCI-1 may be transmitted on a physical sidelink control channel (PSCCH). SCI-1 may include information for resource allocation of a sidelink resource and for decoding of the second stage of sidelink control information (i.e., SCI-2). SCI-1 may further identify a priority level (e.g., Quality of Service (QoS)) of a PSSCH. For example, ultra-reliable-low-latency communication (URLLC) traffic may have a higher priority than text message traffic (e.g., short message service (SMS) traffic). SCI-1 may also include a physical sidelink shared channel (PSSCH) resource assignment and a resource reservation period (if enabled). Additionally, SCI-1 may include a PSSCH demodulation reference signal (DMRS) pattern (if more than one pattern is configured). The DMRS may be used by a receiver for radio channel estimation for demodulation of the associated physical channel. As indicated, SCI-1 may also include information about the SCI-2, for example, SCI-1 may disclose the format of the SCI-2. Here, the format indicates the resource size of SCI-2 (e.g., a number of REs that are allotted for SCI-2), a number of a PSSCH DMRS port(s), and a modulation and coding scheme (MCS) index. In some examples, SCI-1 may use two bits to indicate the SCI-2 format. Thus, in this example, four different SCI-2 formats may be supported. SCI-1 may include other information that is useful for establishing and decoding a PSSCH resource.

SCI-2 may also be transmitted on the PSCCH and may contain information for decoding the PSSCH. According to some aspects, SCI-2 includes a 16-bit layer 1 (L1) destination identifier (ID), an 8-bit L1 source ID, a hybrid automatic repeat request (HARQ) process ID, a new data indicator (NDI), and a redundancy version (RV). For unicast communications, SCI-2 may further include a CSI report trigger. For groupcast communications, SCI-2 may further include a zone identifier and a maximum communication range for NACK. SCI-2 may include other information that is useful for establishing and decoding a PSSCH resource.

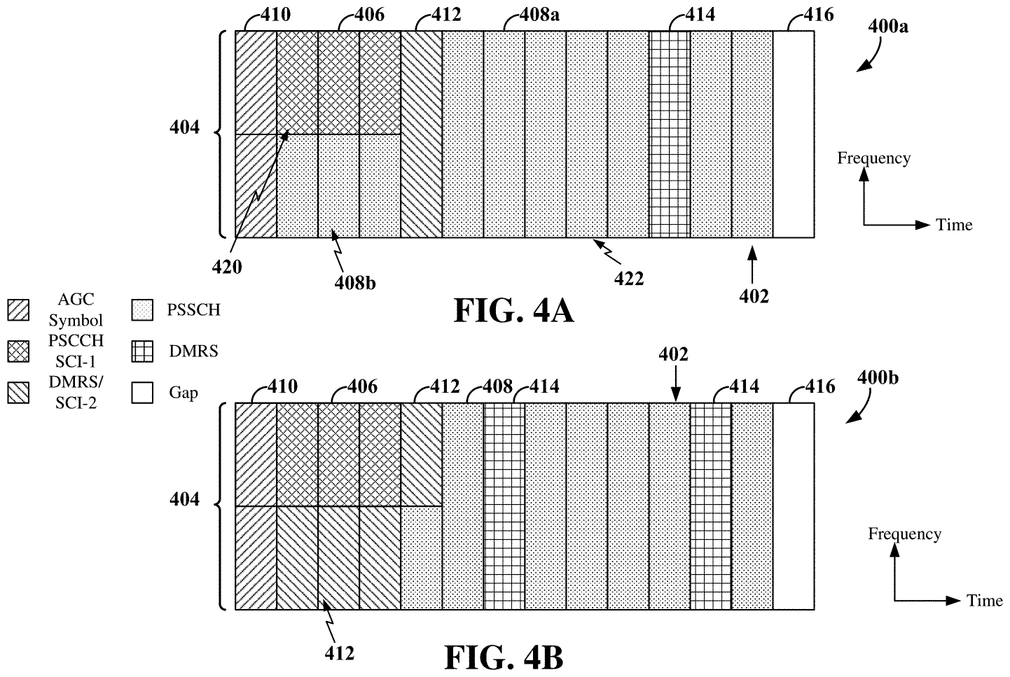

FIGS. 4A and 4B are diagrams illustrating examples of sidelink slot structures according to some aspects. The sidelink slot structures may be utilized, for example, in a V2X or other D2D network implementing sidelink. In the examples shown in FIGS. 4A and 4B, time is in the horizontal direction with units of symbols 402 (e.g., OFDM symbols); and frequency is in the vertical direction. Here, a carrier bandwidth 404 allocated for sidelink wireless communication is illustrated along the frequency axis. The carrier bandwidth 404 may include a plurality of sub-channels, where each sub-channel may include a configurable number of PRBs (e.g., 10, 14, 20, 24, 40, 44, or 100 PRBs).

Each of FIGS. 4A and 4B illustrate an example of a respective slot 400a or 400b including fourteen symbols 402 that may be used for sidelink communication. However, it should be understood that sidelink communication can be configured to occupy fewer than fourteen symbols in a slot 400a or 400b, and the disclosure is not limited to any particular number of symbols 402. Each sidelink slot 400a and 400b includes a physical sidelink control channel (PSCCH) 406 occupying a control region 418 of the slot 400a and 400b and a physical sidelink shared channel (PSSCH) 408 occupying a data region 420 of the slot 400a and 400b. The PSCCH 406 and PSSCH 408 are each transmitted on one or more symbols 402 of the slot 400a. The PSCCH 406 includes, for example, SCI-1 that schedules transmission of data traffic on time-frequency resources of the corresponding PSSCH 408. As shown in FIGS. 4A and 4B, the PSCCH 406 and corresponding PSSCH 408 are transmitted in the same slot 400a and 400b. In other examples, the PSCCH 406 may schedule a PSSCH in a subsequent slot.

In some examples, the PSCCH 406 duration is configured to be two or three symbols. In addition, the PSCCH 406 may be configured to span a configurable number of PRBs, limited to a single sub-channel. For example, the PSCCH 406 may span 10, 12, 14, 20, or 24 PRBs of a single sub-channel. A DMRS may further be present in every PSCCH symbol. In some examples, the DMRS may be placed on every fourth RE of the PSCCH 406. A frequency domain orthogonal cover code (FD-OCC) may further be applied to the PSCCH DMRS to reduce the impact of colliding PSCCH transmissions on the sidelink channel. For example, a transmitting UE may randomly select the FD-OCC from a set of pre-defined FD-OCCs. In each of the examples shown in FIGS. 4A and 4B, the starting symbol for the PSCCH 406 is the second symbol of the corresponding slot 400a or 400b and the PSCCH 406 spans three symbols 402.

The PSSCH 408 may be time-division multiplexed (TDMed) with the PSCCH 406 and/or frequency-division multiplexed (FDMed) with the PSCCH 406. In the example shown in FIG. 4A, the PSSCH 408 includes a first portion 408a that is TDMed with the PSCCH 406 and a second portion 408b that is FDMed with the PSCCH 406. In the example shown in FIG. 4B, the PSSCH 408 is TDMed with the PSCCH 406.

One and two layer transmissions of the PSSCH 408 may be supported with various modulation orders (e.g., quadrature phase-shift keying (QPSK), or quadrature amplitude modulation (QAM) such as 16-QAM, 64-QAM and 246-QAM). In addition, the PSSCH 408 may include DMRSs 414 configured in a two, three, or four symbol DMRS pattern. For example, slot 400a shown in FIG. 4A illustrates a two symbol DMRS pattern, while slot 400b shown in FIG. 4B illustrates a three symbol DMRS pattern. In some examples, the transmitting UE can select the DMRS pattern and indicate the selected DMRS pattern in SCI-1, according to channel conditions. The DMRS pattern may be selected, for example, based on the number of PSSCH 408 symbols in the slot 400a or 400b. In addition, a gap symbol 416 is present after the PSSCH 408 in each slot 400a and 400b.

Each slot 400a and 400b further includes SCI-2 412 mapped to contiguous RBs in the PSSCH 408 starting from the first symbol containing a PSSCH DMRS. In the example shown in FIG. 4A, the first symbol containing a PSSCH DMRS is the fifth symbol occurring immediately after the last symbol carrying the PSCCH 406. Therefore, the SCI-2 412 is mapped to RBs within the fifth symbol. In the example shown in FIG. 4B, the first symbol containing a PSSCH DMRS is the second symbol, which also includes the PSCCH 406. In addition, the SCI-2/PSSCH DMRS 412 are shown spanning symbols two through five. As a result, the SCI-2/PSSCH DMRS 412 may be FDMed with the PSCCH 406 in symbols two through four and TDMed with the PSCCH 406 in symbol five.

The SCI-2 may be scrambled separately from the sidelink shared channel. In addition, the SCI-2 may utilize QPSK. When the PSSCH transmission spans two layers, the SCI-2 modulation symbols may be copied on (e.g., repeated on) both layers. The SCI-1 in the PSCCH 406 may be blind decoded at the receiving wireless communication device. However, since the format, starting location, and number of REs of the SCI-2 412 may be derived from the SCI-1, blind decoding of SCI-2 is not needed at the receiver (receiving UE).

In each of FIGS. 4A and 4B, the second symbol of each slot 400a and 400b is copied onto (repeated on) a first symbol 410 thereof for automatic gain control (AGC) settling. For example, in FIG. 4A, the second symbol containing the PSCCH 406 FDMed with the PSSCH second portion 408b may be transmitted on both the first symbol and the second symbol. In the example shown in FIG. 4B, the second symbol containing the PSCCH 406 FDMed with the SCI-2/PSSCH DMRS 412 may be transmitted on both the first symbol and the second symbol.

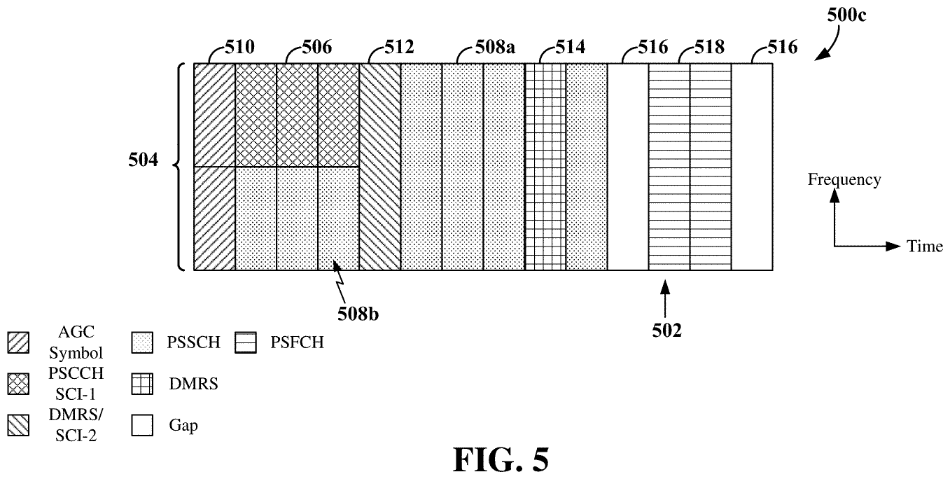

FIG. 5 is a diagram illustrating an example of a sidelink slot structure with feedback resources according to some aspects. The sidelink slot structure may be utilized, for example, in a V2X or other D2D network implementing sidelink. In the example shown in FIG. 5, time is in the horizontal direction with units of symbols 502 (e.g., OFDM symbols); and frequency is in the vertical direction. Here, a carrier bandwidth 504 allocated for sidelink wireless communication is illustrated along the frequency axis. A slot 500 having the slot structure shown in FIG. 5 includes fourteen symbols 502 that may be used for sidelink communication. However, it should be understood that sidelink communication can be configured to occupy fewer than fourteen symbols in a slot 500, and the disclosure is not limited to any particular number of symbols 502.

As in the examples shown in FIGS. 4A and 4B, the sidelink slot 500 includes a

PSCCH 506 occupying a control region of the slot 500 and a PSSCH 508 occupying a data region 520 of the slot 500. The PSCCH 506 and PSSCH 508 are each transmitted on one or more symbols 502 of the slot 500a. The PSCCH 506 includes, for example, SCI-1 that schedules transmission of data traffic on time-frequency resources of the corresponding PSSCH 508. As shown in FIG. 5, the starting symbol for the PSCCH 506 is the second symbol of the slot 500 and the PSCCH 506 spans three symbols 502. The PSSCH 508 may be time-division multiplexed (TDMed) with the PSCCH 506 and/or frequency-division multiplexed (FDMed) with the PSCCH 506. In the example shown in FIG. 5, the PSSCH 508 includes a first portion 508a that is TDMed with the PSCCH 506 and a second portion 508b that is FDMed with the PSCCH 506.

The PSSCH 508 may further include a DMRSs 514 configured in a two, three, or four symbol DMRS pattern. For example, slot 500 shown in FIG. 5 illustrates a two symbol DMRS pattern. In some examples, the transmitting UE can select the DMRS pattern and indicate the selected DMRS pattern in SCI-1, according to channel conditions. The DMRS pattern may be selected, for example, based on the number of PSSCH 508 symbols in the slot 500. In addition, a gap symbol 516 is present after the PSSCH 508 in the slot 500.

The slot 500 further includes SCI-2 512 mapped to contiguous RBs in the PSSCH 508 starting from the first symbol containing a PSSCH DMRS. In the example shown in FIG. 5, the first symbol containing a PSSCH DMRS is the fifth symbol occurring immediately after the last symbol carrying the PSCCH 506. Therefore, the SCI-2 512 is mapped to RBs within the fifth symbol.

In addition, as shown in FIG. 5, the second symbol of the slot 500 is copied onto (repeated on) a first symbol 510 thereof for automatic gain control (AGC) settling. For example, in FIG. 5, the second symbol containing the PSCCH 506 FDMed with the PSSCH second portion 508b may be transmitted on both the first symbol and the second symbol.

HARQ feedback may further be transmitted on a physical sidelink feedback channel (PSFCH) 518 in a configurable resource period of 0, 1, 2, or 4 slots. In sidelink slots (e.g., slot 500) containing the PSFCH 518, one symbol 502 may be allocated to the PSFCH 518, and the PSFCH 518 may be copied onto (repeated on) a previous symbol for AGC settling. In the example shown in FIG. 5, the PSFCH 518 is transmitted on the thirteenth symbol and copied onto the twelfth symbol in the slot 500c. A gap symbol 516 may further be placed after the PSFCH symbols 518.

In some examples, there is a mapping between the PSSCH 508 and the corresponding PSFCH resource. The mapping may be based on, for example, the starting sub-channel of the PSSCH 508, the slot containing the PSSCH 508, the source ID and the destination ID. In addition, the PSFCH can be enabled for unicast and groupcast communication. For unicast, the PSFCH may include one ACK/NACK bit. For groupcast, there may be two feedback modes for the PSFCH. In a first groupcast PSFCH mode, the receiving UE transmits only NACK, whereas in a second groupcast PSFCH mode, the receiving UE may transmit either ACK or NACK. The number of available PSFCH resources may be equal to or greater than the number of UEs in the second groupcast PSFCH mode.

As mentioned above, a UE operating in a wireless communication network (e.g., a D2D network, a V2X network, etc.) may reserve at least one resource for communication of direct signals (e.g., a transmission to another UE). In some examples, the UE broadcasts sidelink control information (SCI) to inform other UEs in the network that the UE has reserved the at least one resource. Accordingly, each UE in the network may detect SCIs sent by other UEs to determine which resources have not yet been reserved (e.g., are free to use). In some examples, SCI is the NR V2X equivalent of a scheduling assignment (SA) used in 3GPP Long Term Evolution (LTE) V2X. As discussed herein, a UE of the network may include, for example, an on-board V2X unit installed in a vehicle as shown in FIG. 2, a cell phone, a laptop, a wearable device, or other suitable wireless communication device.

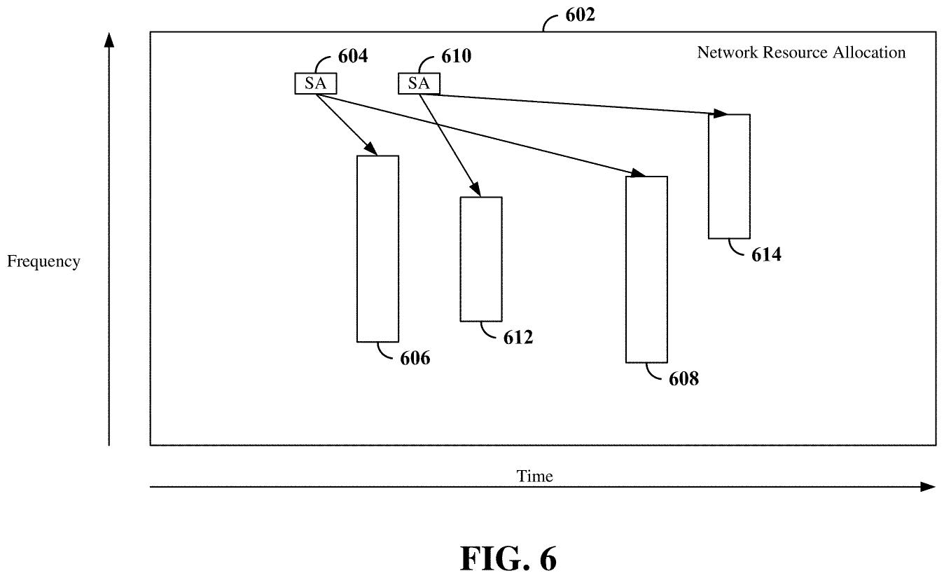

FIG. 6 is a diagram illustrating an example of a resource allocation 602 over a period of time for such a network. Here, time resources (e.g., time slots) and frequency resources (e.g., subcarriers) are allocated for transmission of signals by UEs of the network (not shown). An SCI may indicate that one or more resources are reserved for one or more transmissions. For example, a first resource may be reserved for a first transmission, a second resource may be reserved for a second transmission, and so on. In the example of FIG. 6, a first SCI 604 transmitted by a first UE indicates that a first resource 606 is reserved for a first transmission and a second resource 608 is reserved for a second transmission. Similarly, a second SCI 610 transmitted by a second UE indicates that a first resource 612 is reserved for a first transmission and a second resource 614 is reserved for a second transmission.

The SCI scheme may support retransmission schemes such as a hybrid automatic repeat request (HARQ) scheme. In a retransmission scheme, a UE may retransmit the information sent in the first transmission in an attempt to ensure that any intended receivers will be able to decode the information. For example, a receiver may use HARQ combining of the first transmission and at least one retransmission to decode the information, if applicable.

Accordingly, an SCI may indicate a reserved resource for a transmission and one or more reserved resources for one or more potential retransmissions. Thus, each second transmission referred to above may be a retransmission of the corresponding first transmission (e.g., for HARQ Chase Combining (HARQ-CC) or HARQ Incremental Redundancy (HARQ-IR)). In addition, a UE may indicate in a subsequent transmission (e.g., in scheduling information associated with a retransmission) that resources that are reserved for one or more subsequent retransmissions.

In some examples, a UE may detect SCIs transmitted by other UEs so that the UE will know which resources are currently reserved for a period of time. In a sidelink network, a UE may detect SCIs on a physical sidelink control channel (PSCCH) or some other type of channel.

In some examples, a UE may use a threshold to determine whether a particular SCI is to be taken into consideration for purposes of resource reservation. A first UE may receive an SCI (and other signals) from a second UE that is relatively far away from the first UE. In this case, the received signal strength of such signaling at the first UE may be relatively low. Consequently, any potential interference (e.g., signaling collisions) between the first UE and the second UE (e.g., if both UEs transmit at the same time) may be relatively minor. For example, the respective receivers for these transmissions may be able to successfully decode the transmissions despite the interference. Consequently, the first UE may ignore an SCI from the second UE if the first UE determines that a received signal strength of a signal from the second UE is below a threshold (e.g., “X” dB). In some examples, such a threshold (e.g., which may be referred to as a resource reservation threshold) may be configured by the network. In some examples, the determination of the received signal strength involves measuring a received signal strength of a PSCCH signal and/or a physical sidelink shared channel (PSCCH) signal. In some examples, the determination of the received signal strength involves measuring a reference signal received power (RSRP).

When a UE has information to be transmitted over a direct link, the UE may identify candidate resources for the transmission for a particular period of time. The candidate resources include the resources that can accommodate the transmission and that are available for use. In some examples, the resources that can accommodate the transmission may include the resources that are large enough to accommodate the size of a packet that will be transmitted. In some examples, the resources that are available for use may include resources that are not reserved by another UE. In some examples, the resources that are available for use also may include resources that are reserved by a UE but where a corresponded received signal strength for that UE is below the resource reservation threshold.

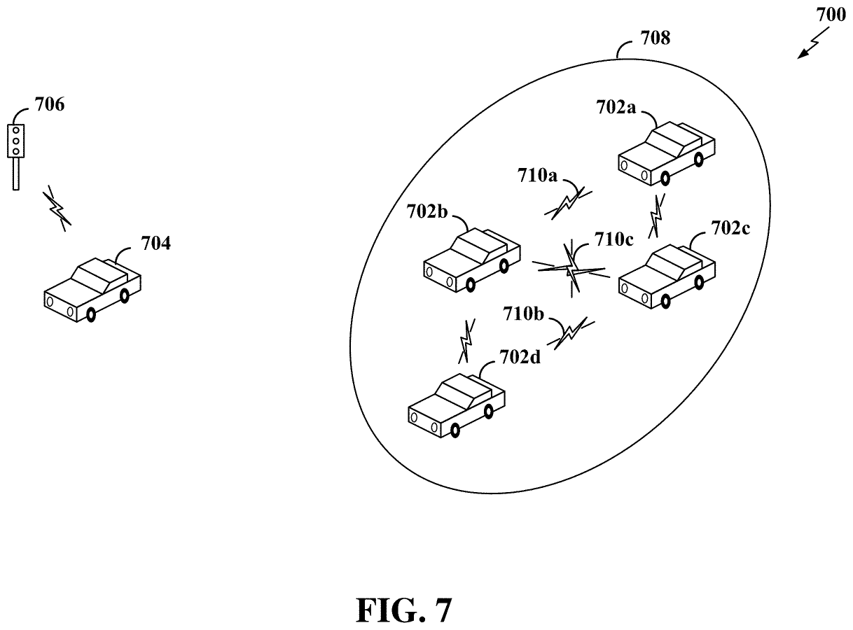

As mentioned above, a set of UEs may form a group where information is groupcast to the UEs of the group. FIG. 7 is a diagram illustrating an example of a direct wireless communication system 700 that includes a group of UEs. The direct wireless communication system 700 may include, for example, one or more of a D2D wireless communication network, a V2X or V2P wireless communication network, a P2P wireless communication network (e.g., Bluetooth), some other direct wireless communication network, or a combination thereof.

The direct wireless communication system 700 includes a first UE 702a, a second UE 702b, a third UE 702c, a fourth UE 702d, a fifth UE 704, and a sixth UE 706. Each of the first UE 702a—the fourth UE 702d may include, for example, an on-board V2X unit installed in a vehicle as shown in FIG. 3 or some other wireless communication device (e.g., as shown in any of FIGS. 1, 3, 5, 8, 9, and 11) that is currently in a vehicle. The fifth UE 704 may include, for example, a cell phone, a laptop, a wearable device, or some other type of wireless communication device as shown in any of FIGS. 1, 3, 5, 8, 9, and 11. The sixth UE 706 may include, for example, an infrastructure device as shown in FIG. 3 or some other type of wireless communication device (e.g., as shown in any of FIGS. 1, 3, 5, 8, 9, and 11).

In the example of FIG. 7, the first UE 702a, the second UE 702b, the third UE 702c, and the fourth UE 702d form a group 708. In some examples, the first UE 702a, the second UE 702b, the third UE 702c, and the fourth UE 702d may communicate with one another over respective direct links (e.g., a sidelink, a P2P link, a D2D link, or other suitable direct link). For example, the first UE 702a and the second UE 702b may communicate via a link 710a, the third UE 702c and the fourth UE 702d may communicate via a link 710b, and so on. In addition, the first UE 702a, the second UE 702b, the third UE 702c, and the fourth UE 702d may communicate groupcast messages via one or more links (e.g., as represented by a link 710c). In some examples, a groupcast message may have a range requirement. For example, the message may be intended only for those UEs (e.g., members of the group) that are within a certain range of (e.g., distance from) the UE that sent the message.

As discussed herein, a transmission by any UE of the group 708 might or might not interfere with communication of the fifth UE 704. For example, a transmission by the fourth UE 702d that is relatively close to the fifth UE 704 might interfere with communication of the fifth UE 704 (e.g., the RSRP of signals from the fourth UE 702d as measured by the fifth UE 704 may be relatively high). Conversely, a transmission by the first UE 702a that is not relatively close to the fifth UE 704 might not interfere with communication of the fifth UE 704 (e.g., the RSRP of signals from the first UE 702a as measured by the fifth UE 704 may be relatively low). Thus, in some examples, a resource reservation by the fifth UE 704 may take into account resource reservations (e.g., SCI signaling) by UEs of the group 708.

In some examples, groupcast communication in the group 708 may employ feedback to improve the efficiency and/or reliability of the groupcast communication. For example, a UE of the group 708 that sends a groupcast message may determine whether to retransmit the message based on feedback from the other members of the group 708. Here, UEs of the group may determine that a first UE of the group is transmitting a groupcast message based on an SCI transmitted by the first UE. Thus, UEs of the group (e.g., UEs within the range requirement of the message) may attempt to decode the groupcast transmission on the resource indicated by the SCI.

A first type of feedback-based retransmission for groupcast may be referred to as option 1 groupcast feedback. In option 1, a UE that does not successfully receive an expected groupcast message sends a negative acknowledgment (NACK). For example, this UE may send a designated feedback sequence on a feedback channel. In some examples, the feedback channel is a physical sidelink feedback channel (PSFCH).

In contrast, a UE that successfully receives an expected groupcast message does not send any feedback in option 1. In some examples, this feedback mechanism may be relatively efficient since no additional signals are transmitted if a transmission is successful (e.g., no feedback is sent if all of the UEs in the group expecting the message successfully received the message).

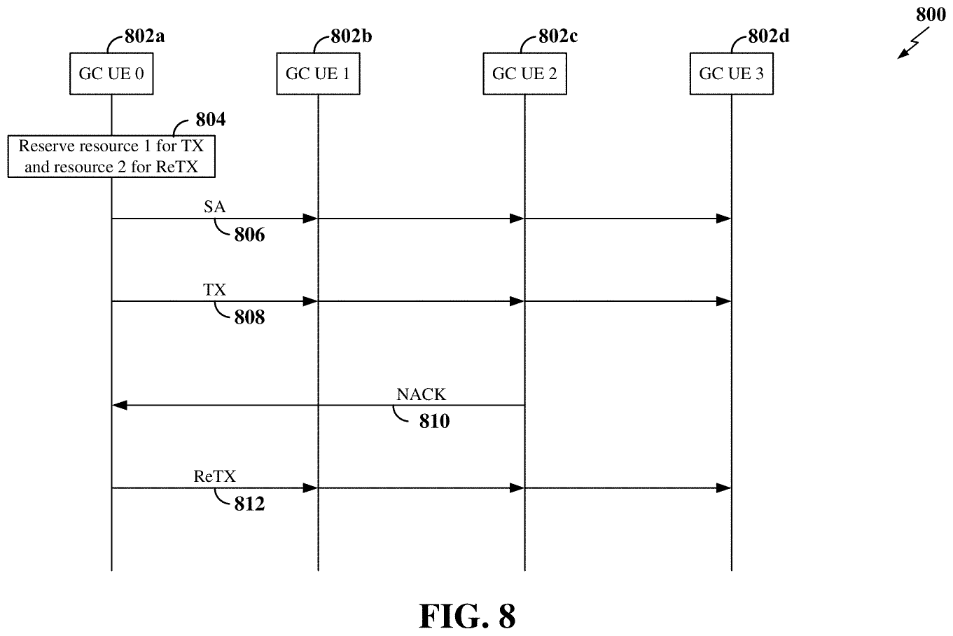

FIG. 8 is a signaling diagram illustrating an example of option 1 groupcast feedback within a direct wireless communication system 800. The wireless communication system 800 may correspond, for example, to any of the wireless communication systems shown in any of FIGS. 1, 3, 7, and 9. The direct wireless communication system 800 may include, for example, one or more of a D2D wireless communication network, V2X/V2P wireless communication network, P2P wireless communication network (e.g., Bluetooth), and/or other direct wireless communication network.

The direct wireless communication system 800 includes a plurality of groupcast UEs (GC UEs): a first UE 802a, a second UE 802b, a third UE 802c, and a fourth UE 802d. Each of the UEs 802a-802d may be, for example, a wireless communication device as shown in any of FIGS. 1, 3, 7, 9, and 11. In some examples, the first UE 802a, the second UE 802b, the third UE 802c, and the fourth UE 802d may correspond to the first UE 702a, the second UE 702b, the third UE 702c, and the fourth UE 702d of FIG. 7, respectively.

At 804, a first UE 802a (e.g., GC UE 0) may reserve a first resource (resource 1) for a groupcast transmission (groupcast option 1) and reserve at least one second resource (resource 2) for at least one potential retransmission of the first transmission, if applicable. For example, the first UE 802a may pre-reserve the resources for a HARQ retransmission in the event the groupcast transmission is not successful.

At 806, the first UE 802a may transmit (e.g., broadcast) an SCI. In some examples, the SCI indicates that the first UE 802a has reserved resource 1 for a groupcast option 1 transmission and resource 2 for a potential retransmission of the groupcast retransmission.

At 808, the first UE 802a may transmit a groupcast option 1 message to the UEs 802b-802d via resource 1. This message is successfully received by the second UE 802b and the fourth UE 802d. Consequently, the second UE 802b and the fourth UE 802d do not send negative acknowledgements (NACKs).

However, the third UE 802c does not successfully receive the groupcast option 1 message. Consequently, at 810, the third UE 802c sends a NACK on a feedback channel (e.g., PSFCH).

At 812, as a result of receiving at least one NACK in response to the groupcast option 1 message, the first UE 802a retransmits the groupcast option 1 message to the UEs 802b-802d via resource 2.

As discussed above, in option 1, if a UE that sends a groupcast message does not receive any feedback, it may be assumed that all of the intended receivers of the message successfully received the transmission. Consequently, the UE does not retransmit the message (e.g., to prevent needless signaling). For example, in FIG. 8, if the third UE 802c had not sent a NACK at 810, the first UE 802a would not have retransmitted the message at 812.

A second type of feedback-based retransmission for groupcast may be referred to as option 2 groupcast feedback. In option 2, a UE that expects to receive a groupcast message sends feedback indicative of whether the UE successfully received the message. For example, a UE that successfully receives an expected groupcast message may send a positive acknowledgement (ACK). Conversely, a UE that does not successfully receive an expected groupcast message may send a NACK. For example, a UE may send a corresponding designated feedback sequence on a feedback channel. In some examples, the feedback channel is a physical sidelink feedback channel (PSFCH).

In some examples, the UE sending the message will retransmit unless it receives explicit feedback from every intended receiver indicating that the message was successfully received. This is in contrast with option 1 where a UE that did not successfully receive a groupcast message might not send a NACK. For example, a second UE may have been transmitting when a first UE sent a SCI indicating that a groupcast message will be sent. Thus, the second UE might not attempt to decode the message or send a NACK if it fails to decode the message.

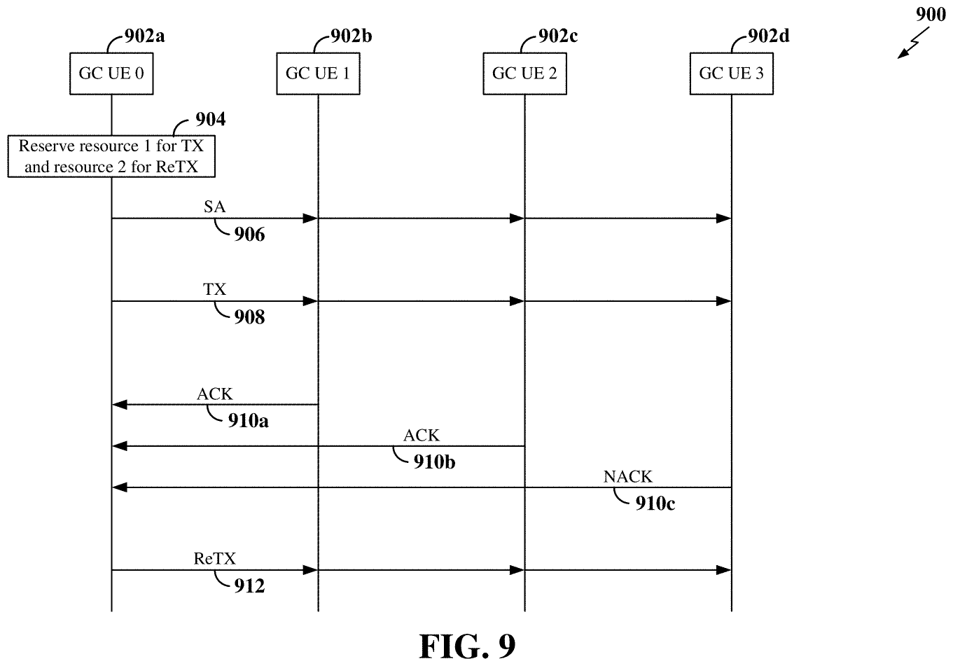

FIG. 9 is a signaling diagram illustrating an example of option 2 groupcast feedback within a direct wireless communication system 900. The wireless communication system 900 may correspond, for example, to any of the wireless communication systems shown in any of FIGS. 1, 3, 7, and 8. The direct wireless communication system 900 may include, for example, one or more of a D2D wireless communication network, V2X/V2P wireless communication network, P2P wireless communication network (e.g., Bluetooth), and/or other direct wireless communication network.

The direct wireless communication system 900 includes a plurality of groupcast

UEs (GC UEs): a first UE 902a, a second UE 902b, a third UE 902c, and a fourth UE 902d. Each of the UEs 902a-902d may be, for example, a wireless communication device as shown in any of FIGS. 1, 3, 7, 8, and 11. In some examples, the first UE 902a, the second UE 902b, the third UE 902c, and the fourth UE 902d may correspond to the first UE 702a, the second UE 702b, the third UE 702c, and the fourth UE 702d of FIG. 7, respectively.

At 904, a first UE 902a (e.g., GC UE 0) may reserve a first resource (resource 1) for a groupcast transmission (groupcast option 2) and reserve at least one second resource (resource 2) for at least one potential retransmission of the first transmission, if applicable. For example, the first UE 902a may pre-reserve the resources for a HARQ retransmission in the event the groupcast transmission is not successful.

At 906, the first UE 902a may transmit (e.g., broadcast) an SCI. In some examples, the SCI indicates that the first UE 902a has reserved a first resource (resource 1) for a groupcast option 2 transmission and at least one second resource (resource 2) for at least one potential retransmission of the groupcast retransmission.

At 908, the first UE 902a may transmit a groupcast option 2 message to the UEs 902b-902d via resource 1.

The second UE 902b successfully receives the groupcast option 2 message. Consequently, at 910a, the second UE 902b sends a positive acknowledgement (ACK) on a feedback channel (e.g., PSFCH).

The third UE 902c successfully receives the groupcast option 2 message. Consequently, at 910b, the third UE 902c sends an ACK on a feedback channel (e.g., PSFCH).

The fourth UE 902d does not successfully receive the groupcast option 2 message. Consequently, at 910c, the fourth UE 902d sends a NACK on a feedback channel (e.g., PSFCH).

At 910, as a result of not receiving an ACK from each of the second UE 902b, the third UE 902c, and the fourth UE 902d (or, alternatively, as a result of receiving at least one NACK) in response to the groupcast option 2 message, the first UE 902a retransmits the groupcast option 2 message to the UEs 902b-902d via resource 2.

As discussed above, in option 2, if a UE that sends a groupcast message receives ACKs from all of the intended receivers of the message, the UE does not retransmit the message (e.g., to prevent needless signaling). For example, in FIG. 9, if the fourth UE 902d had sent an ACK at 910c instead of a NACK, the first UE 902a would not have retransmitted the message at 912.

From the above, it should be appreciated that in both option 1 and option 2, the resource scheduled by a first UE (e.g., the first UE 802a of FIG. 8 or the first UE 902a of FIG. 9) for a retransmission remains scheduled even if the UE does not retransmit. However, a nearby UE (e.g., the fifth UE 704 of FIG. 7) that received the SCI transmitted by the first UE may still expect the first UE to use the at least one second resource for at least one retransmission. Thus, the fifth UE 704 (as well as any other nearby UEs) might not attempt to select any resource that overlaps with the at least one second resource. Accordingly, resources in the system may be wasted.

To address this potential waste of resources, a UE may be configured to detect feedback associated with a first transmission (e.g., for option 1 or option 2 groupcast feedback). In this way, a UE may determine whether there will be a retransmission. If there will not be a retransmission, the UE may elect to use a resource that overlaps with a resource previously reserved for the retransmission (e.g., the UE may reclaim the resource).

In some examples, for option 1 groupcast feedback, a first UE may monitor a feedback channel for negative feedback sequences (e.g., NACKs) associated with a first transmission by a second UE. If there are no negative feedback sequences transmitted for the first transmission, the first UE may determine that the second UE will not send a retransmission on a resource that the second UE previously reserved for the retransmission. Thus, the first UE may attempt to select a resource that overlaps with that previously reserved resource.

In some examples, for option 2 groupcast feedback, a first UE may monitor a feedback channel for positive feedback sequences (e.g., ACKs) and/or negative feedback sequences (e.g., NACKs) associated with a first transmission by a second UE. If all of the feedback sequences transmitted for the first transmission are positive feedback sequences, the first UE may determine that the second UE will not send a retransmission on a resource that the second UE previously reserved for the retransmission. Thus, the first UE may attempt to select a resource that overlaps with that previously reserved resource.

In some scenarios, however, a UE could expend considerable resources detecting feedback. For example, if there are a large number of nearby UEs that use option 2 groupcast feedback, it may be undesirable (e.g., impractical) for the UE to detect (e.g., receive and decode) all of the feedback sequences transmitted by all of the nearby UEs. Also, in some cases, a UE might not be able to or might not be configured to decode a feedback sequence transmitted by another UE. For example, a UE that has to transmit feedback might not be able to detect feedback at the same time.

The disclosure relates in some aspects to reducing feedback monitoring at a UE. For example, a first UE may elect to not detect feedback associated with transmissions by certain UEs.

In some examples, the utilization rate of feedback resources may be relatively low (e.g., 10 to 30 percent). Moreover, as discussed above, the negative effects of interference between UEs that are relatively far from one another may be relatively minimal.

Accordingly, selective feedback detection at a first UE may be based on a received signal strength of a signal received from a second UE. For example, if the RSRP measured at the first UE for a signal received from the second UE is below a threshold, the first UE may elect to not detect feedback associated with transmissions by the second UE. Here, since the distance between the first UE and the second UE is relatively far as indicated by the RSRP measured at the first UE being relatively low), interference between the first UE and the second UE may be relatively low. Consequently, the first UE may deem any resource reserved by the second UE for a retransmission as being available to the first UE. Thus, the first UE may include in a candidate set at least one resource that overlaps with the reserved resource(s) (e.g., assuming any other resource conditions are met) without detecting feedback associated with the first transmission by the second UE. As such, the SCI detection process at the first UE may be more efficient in this case (e.g., the first UE will not process as many feedback sequences).

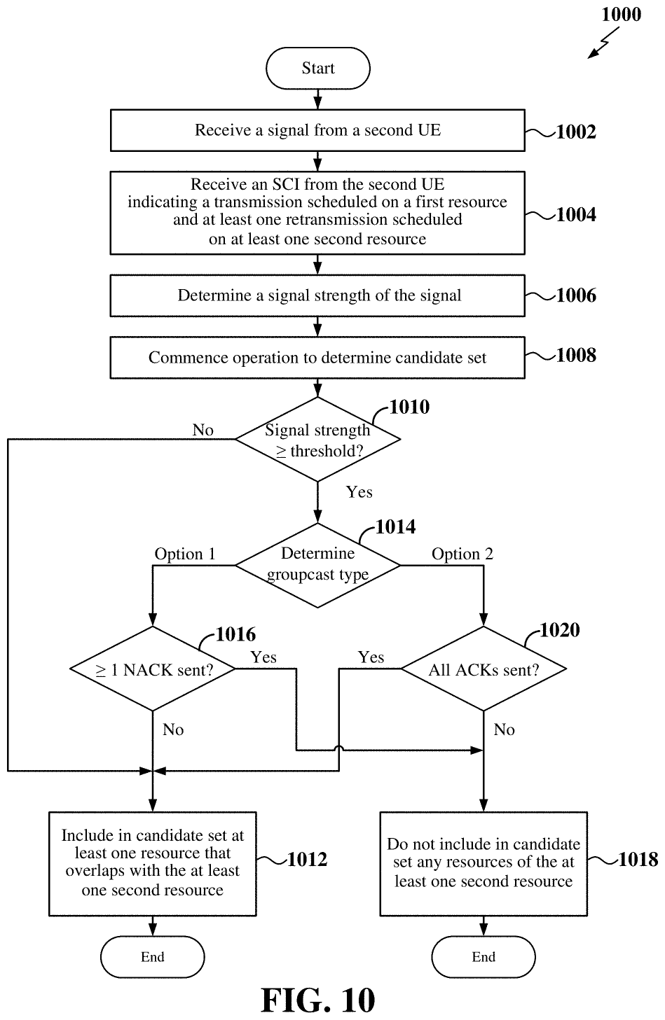

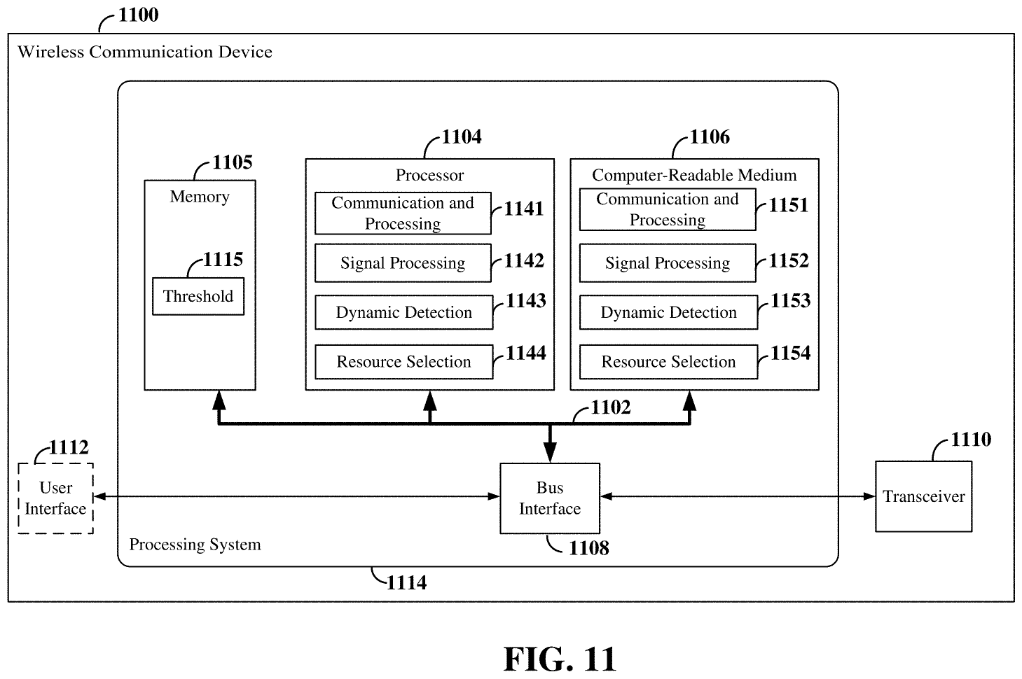

FIG. 10 is a flow chart of a method 1000 for a UE to schedule resources according to some aspects. As described below, some or all illustrated features may be omitted in a particular implementation within the scope of the present disclosure, and some illustrated features may not be required for implementation of all examples. In some examples, the method may be performed by the wireless communication device 1100 (e.g., performed by the processing system 1114), as described above and illustrated in FIG. 11, by a processor or processing system, or by any suitable means for carrying out the described functions.

At block 1002, a first UE may receive a signal from a second UE. For example, the first UE may monitor PSCCH signaling and/or PSSCH signaling for reselection purposes.

At block 1004, the first UE may receive an SCI transmitted by the second UE. In some examples, the SCI may indicate that the second UE reserved a first resource of a plurality of resources for a groupcast transmission and at least one second resource of the plurality of resources for at least one retransmission of the groupcast transmission, if applicable.

At block 1006, the first UE may determine a received signal strength of the received signal (e.g., measure a signal strength of the signal). For example, the first UE may determine an RSRP indication for the signal received at block 1002.

At block 1008, the first UE commences an operation to determine a candidate set of free resources. For example, the first UE may perform the operations that follow to identify at least one available resource for the candidate set.

At block 1010, the first UE determines whether the signal strength determined at block 1004 is greater than or equal to a threshold. For example, the first UE may determine, based on the signal strength, whether the second UE is sufficiently far from the first UE (e.g., so that the communications by these UEs do not significantly interfere with one another).

In some examples, the threshold may be configured by the network. For example, the network may determine the threshold to be used (e.g., based on measurements and/or simulations) and send an indication of the threshold to the first UE. In some examples, the threshold may be specified by a communication standard or specification (e.g., a D2D standard or specification).

In some examples, the threshold may be based on a resource reservation threshold as discussed herein. For example, the threshold may be set to a value equal to the resource reservation threshold plus a delta (e.g., in dB).

In some examples, the threshold may be based on a traffic load in a network. For example, the threshold may be set to a value that varies based on the traffic load. In some examples, a traffic load indicator may take the form of a channel busy ratio (CBR). As one example, a first threshold (e.g., 5 dB above the resource reservation threshold) may be used when the traffic load is light, a second threshold (e.g., 10 dB above the resource reservation threshold) may be used when the traffic load is medium, and a third threshold (e.g., 10-15 dB above the resource reservation threshold) may be used when the traffic load is heavy. Other relationships between traffic load and the threshold may be used in other examples.

In some examples, the threshold may be defined in an attempt to ensure that a certain percentage of the available resources remain free. For example, the threshold may be set to a value such that a certain percent (e.g., 50%) of the allocated V2X resources remain free. In some examples, this determination may be based on resource information collected over a period of time and based on the threshold values used during that period of time.

If the signal strength was not greater than or equal to the threshold at block 1010 (e.g., the second UE is sufficiently far away), the first UE does not detect the feedback associated with the groupcast transmission by the second UE. Instead, the operational flow proceeds to block 1012 where the first UE includes in the candidate set at least one resource that overlaps with the at least one second resource. In this case, the first UE may subsequently elect to use this resource for a transmission irrespective of whether the second UE will be transmitting on that resource (e.g., the UE may reclaim the at least one second resource).

If the signal strength was greater than or equal to the threshold at block 1010 (e.g., the second UE is not sufficiently far away), the operational flow proceeds to block 1014 where the first UE determines the type of groupcast scheduled by the SCI that was received at block 1006. In some examples, the second UE may indicate the groupcast type in control information transmitted by the second UE (e.g., on PSCCH).

If the groupcast is determined to be an option 1 groupcast at block 1014, the operational flow proceeds to block 1016 where the first UE monitors a feedback channel to determine whether at least one NACK was sent in response to the option 1 groupcast. In some examples, the second UE may indicate in control information transmitted by the second UE (e.g., on PSCCH) which feedback sequences are applicable to the groupcast.

If the UE determines at block 1016 that no NACKs were sent in response to the option 1 groupcast, the second UE is not expected to send a retransmission on the at least one second resource. Thus, the operational flow proceeds to block 1012 where the first UE includes in the candidate set at least one resource that overlaps with the at least one second resource.

Conversely, if it is determined at block 1016 that at least one NACK was sent in response to the option 1 groupcast, the operational flow proceeds to block 1018. Here, the second UE is expected to send a retransmission on the at least one second resource. Since the at least one second resource is not available, the first UE will not include in the candidate set any resource of the at least one second resource. In addition, the first UE may continue to monitor for other available resources (e.g., the operational flow may return back to block 1002).

If the groupcast is determined to be an option 2 groupcast at block 1014, the operational flow proceeds to block 1020 where the first UE monitors a feedback channel to determine whether all of the expected ACKs were sent in response to the option 2 groupcast. If so (e.g., the second UE is not expected to send a retransmission on the at least one second resource), the operational flow proceeds to block 1012 where the first UE includes in the candidate set at least one resource that overlaps with the at least one second resource.

Conversely, if it is determined at block 1020 that not all of the ACKs were sent (or that at least one NACK was sent) in response to the option 2 groupcast the operational flow proceeds to block 1018 where the first UE will not include in the candidate set any resource of the at least one second resource. In addition, the first UE may continue to monitor for other available resources (e.g., the operational flow may return back to block 1002).

In view of the above, it may be seen that the first UE may efficiently select resources for a candidate set using the method 1000 since detection of feedback may be avoided in some cases. Thus, UEs in a network may be able to select from a larger pool of collision-free resources, thereby improving the efficiency and performance of the network.

FIG. 11 is a conceptual diagram illustrating an example of a hardware implementation for a wireless communication device 1100 employing a processing system 1114. For example, the wireless communication device 1100 may be a UE, D2D device, or V2X device as illustrated in any of FIGS. 1, 3, and 7-9.

The wireless communication device 1100 may be implemented with a processing system 1114 that includes one or more processors 1104. Examples of processors 1104 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the wireless communication device 1100 may be configured to perform any one or more of the functions described herein. That is, the processor 1104, as utilized in a wireless communication device 1100, may be used to implement any one or more of the processes described below. The processor 1104 may in some instances be implemented via a baseband or modem chip and in other implementations, the processor 1104 may itself include a number of devices distinct and different from a baseband or modem chip (e.g., in such scenarios these devices may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1114 may be implemented with a bus architecture, represented generally by the bus 1102. The bus 1102 may include any number of interconnecting buses and bridges depending on the specific application of the processing system 1114 and the overall design constraints. The bus 1102 communicatively couples together various circuits including one or more processors (represented generally by the processor 1104), a memory 1105, and computer-readable media (represented generally by the computer-readable medium 1106). The bus 1102 may also link various other circuits such as timing sources, peripherals, voltage regulators, and power management circuits, which are well known in the art, and therefore, will not be described any further. A bus interface 1108 provides an interface between the bus 1102 and a transceiver 1110. The transceiver 1110 provides a means for communicating with various other apparatus over a transmission medium (e.g., air interface). A user interface 1112 (e.g., keypad, display, speaker, microphone, joystick) may also be provided.

The processor 1104 is responsible for managing the bus 1102 and general processing, including the execution of software stored on the computer-readable medium 1106. The software, when executed by the processor 1104, causes the processing system 1114 to perform the various functions described below for any particular apparatus. The computer-readable medium 1106 and the memory 1105 may also be used for storing data that is manipulated by the processor 1104 when executing software. For example, the memory 1105 may store threshold information 1115 (e.g., for signal measurements) used by the processor 904 in cooperation with the transceiver 910 to control communication operations as described herein.

One or more processors 1104 in the processing system may execute software.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1106.

The computer-readable medium 1106 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium 1106 may reside in the processing system 1114, external to the processing system 1114, or distributed across multiple entities including the processing system 1114. The computer-readable medium 1106 may be embodied in a computer program product. In some examples, the computer-readable medium 1106 may be part of the memory 1105. By way of example, a computer program product may include a computer-readable medium in packaging materials. Those skilled in the art will recognize how best to implement the described functionality presented throughout this disclosure depending on the particular application and the overall design constraints imposed on the overall system.

In some aspects of the disclosure, the processor 1104 may include circuitry configured for various functions. For example, the processor 1104 may include circuitry for performing the method 1000 of FIG. 10. In some aspects, processor 1104 may include circuitry for performing one or more of the operations described herein with respect to FIGS. 6-10 and 12-18.

The processor 1104 may include communication and processing circuitry 1141, configured to communicate with a base station and one or more other wireless communication devices over a common carrier shared between a cellular (e.g., Uu) interface and a sidelink (e.g., PC5) interface. In some examples, the communication and processing circuitry 1141 may include one or more hardware components that provide the physical structure that performs processes related to wireless communication (e.g., signal reception and/or signal transmission) and signal processing (e.g., processing a received signal and/or processing a signal for transmission). The communication and processing circuitry 1141 may further be configured to execute communication and processing software 1151 stored on the computer-readable medium 1106 to implement one or more functions described herein.

In some implementations where the communication involves receiving information, the communication and processing circuitry 1141 may obtain information from a component of the wireless communication device 1100 (e.g., from the transceiver 1110 that receives the information via radio frequency signaling or some other type of signaling suitable for the applicable communication medium), process (e.g., decode) the information, and output the processed information. For example, the communication and processing circuitry 1141 may output the information to another component of the processor 1104, to the memory 1105, or to the bus interface 1108. In some examples, the communication and processing circuitry 1141 may receive one or more of signals, messages, SCIs, feedback, other information, or any combination thereof. In some examples, the communication and processing circuitry 1141 may receive information via one or more of a PSCCH, a PSSCH, a PSFCH, some other type of channel, or any combination thereof. In some examples, the communication and processing circuitry 1141 may include functionality for a means for receiving (e.g., means for receiving a signal and/or means for receiving control information). In some examples, the communication and processing circuitry 1141 may include functionality for a means for decoding.

In some implementations where the communication involves sending (e.g., transmitting) information, the communication and processing circuitry 1141 may obtain information (e.g., from another component of the processor 1104, the memory 1105, or the bus interface 1108), process (e.g., encode) the information, and output the processed information. For example, the communication and processing circuitry 1141 may output the information to the transceiver 1110 (e.g., that transmits the information via radio frequency signaling or some other type of signaling suitable for the applicable communication medium). In some examples, the communication and processing circuitry 1141 may send one or more of signals, messages, SCIs, feedback, other information, or any combination thereof. In some examples, the communication and processing circuitry 1141 may send information via one or more of a PSCCH, a PSSCH, a PSFCH, some other type of channel, or any combination thereof. In some examples, the communication and processing circuitry 1141 may include functionality for a means for sending (e.g., means for transmitting). In some examples, the communication and processing circuitry 1141 may include functionality for a means for encoding.

The processor 1104 may further include signal processing circuitry 1142, configured to determine an RSRP associated with a signal (e.g., measure a signal strength of the signal). In some examples, the signal processing circuitry 1142 may be configured to perform one or more of the signal processing-related operations described herein (e.g., including those described in conjunction with FIGS. 6-10). In some examples, the signal processing circuitry 1142 may include functionality for a means for receiving a signal. For example, the signal processing circuitry 1142 may monitoring a PSCCH and/or a PSSCH and decode signaling received on the PSCCH and/or the PSSCH. In some examples, the signal processing circuitry 1142 may include functionality for a means for measuring a signal strength. For example, the signal processing circuitry 1142 may generate an RSRP indication by monitoring (e.g., over a period of time) a PSCCH and/or a PSSCH. In some examples, the signal processing circuitry 1142 may provide a reference signal received power indication by monitoring one or more reference signals. The signal processing circuitry 1142 may further be configured to execute signal processing software 1152 stored on the computer-readable medium 1106 to implement one or more functions described herein.

The processor 1104 may further include dynamic detection circuitry 1143, configured to determine whether to detect feedback associated with a transmission. In some examples, the dynamic detection circuitry 1143 may be configured to perform one or more of the detection-related operations described herein (e.g., including those described in conjunction with FIGS. 6-10). In some examples, the dynamic detection circuitry 1143 may include functionality for a means for decoding feedback or abstaining from detecting feedback. In some examples, the dynamic detection circuitry 1143 may include functionality for a means for determining whether to detect feedback. In some examples, the dynamic detection circuitry 1143 may include functionality for a means for determining whether to detect a channel. For example, the dynamic detection circuitry 1143 may determine, based on a received signal strength indication, whether to detect (e.g., monitor for and decode) feedback from member of a groupcast group in response to a groupcast transmission. In some examples, the dynamic detection circuitry 1143 elects to detect feedback if a received signal strength is greater than or equal to a threshold. Otherwise, the dynamic detection circuitry 1143 may elect to not detect feedback. The dynamic detection circuitry 1143 may further be configured to execute dynamic detection software 1153 stored on the computer-readable medium 1106 to implement one or more functions described herein.

The processor 1104 may further include resource selection circuitry 1144, configured to select a resource for communication by the wireless communication device 1100. In some examples, the signal processing circuitry 1142 may be configured to perform one or more of the resource selection-related operations described herein (e.g., including those described in conjunction with FIGS. 6-10). In some examples, the resource selection circuitry 1144 may include functionality for a means for conducting a resource selection operation. In some examples, the resource selection circuitry 1144 may include functionality for a means for determining a candidate set. In some examples, the resource selection circuitry 1144 may include functionality for a means for determining whether to include in a candidate set at least one resource that overlaps with at least one second resource. In some examples, the resource selection circuitry 1144 may include functionality for a means for scheduling a communication. In some examples, the resource selection circuitry 1144 may include functionality for a means for determining whether a wireless communication device will perform a retransmission. In some examples, the resource selection circuitry 1144 may include functionality for a means for determining whether to schedule a communication. In some examples, the resource selection circuitry 1144 may include functionality for a means for defining a threshold. For example, the resource selection circuitry 1144 may determine, based on a received signal strength indication (and, optionally, feedback from a member of a groupcast group), whether to include in the candidate set at least one resource that overlaps with a resource that was previously reserved by another wireless communication device for a retransmission for a groupcast transmission. If a received signal strength associated with the other wireless communication device is less than or equal to a threshold, the resource selection circuitry 1144 may, without detecting feedback associated with a transmission by the other wireless communication device, include in the candidate set at least one resource that overlaps with a resource previously reserved by the other wireless communication device for a retransmission. Alternatively, the resource selection circuitry 1144 may determine, based on feedback associated with a transmission by the other wireless communication device, whether to include in the candidate set at least one resource that overlaps with a resource previously reserved by the wireless communication device for a retransmission. The resource selection circuitry 1144 may further be configured to execute resource selection software 1154 stored on the computer-readable medium 1106 to implement one or more functions described herein.

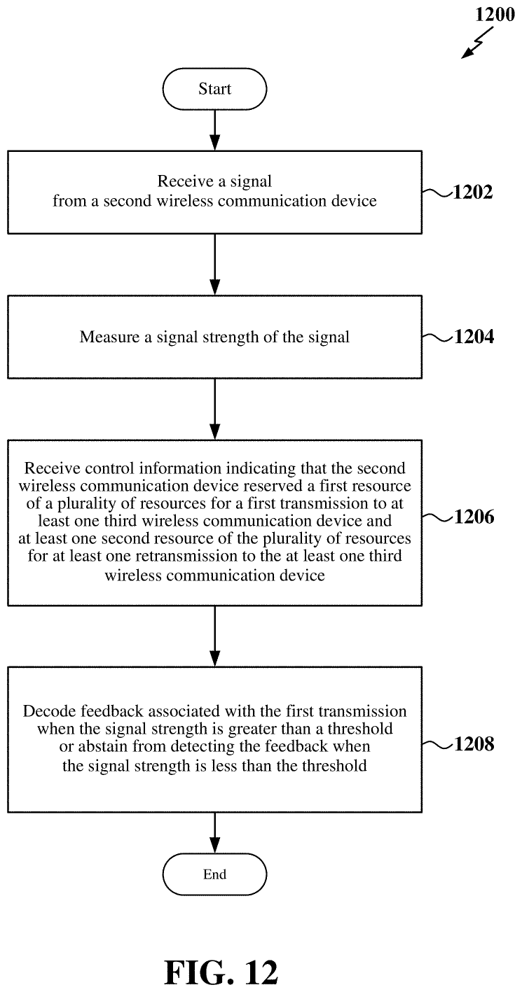

FIG. 12 is a flow chart of a method 1200 for a wireless communication device according to some aspects. As described below, some or all illustrated features may be omitted in a particular implementation within the scope of the present disclosure, and some illustrated features may not be required for implementation of all examples. In some examples, the method 1200 may be performed by the wireless communication device 1100 (e.g., performed by the processing system 1114), as described above and illustrated in FIG. 11, by a processor or processing system, or by any suitable means for carrying out the described functions.

At block 1202, a first wireless communication device may receive a signal from a second wireless communication device. In some examples, receiving the signal from the second wireless communication device may include receiving the signal via a physical sidelink control channel (PSCCH) or a physical sidelink shared channel (PSSCH). For example, the communication and processing circuitry 1141 and transceiver 1110, shown and described above in connection with FIG. 11, may monitor at least one of PSCCH signaling, PSSCH signaling, other signaling, or a combination thereof, from the second wireless communication device.

At block 1204, the first wireless communication device may measure a signal strength of the signal. For example, the signal processing circuitry 1142 and/or the communication and processing circuitry 1141, shown and described above in connection with FIG. 11, may process the signal received at block 1202 to determine a received signal strength of the signal. In some examples, the signal strength is a reference signal received power (RSRP).

At block 1206, the first wireless communication device may receive control information (e.g., sidelink control information) indicating that the second wireless communication device reserved a first resource of a plurality of resources for a first transmission to at least one third wireless communication device and at least one second resource of the plurality of resources for at least one retransmission to the at least one third wireless communication device. For example, the resource selection circuitry 1144, together with the communication and processing circuitry 1141 and the transceiver 1110, shown and described above in connection with FIG. 11 may receive an SCI from the second wireless communication device and decode the SCI to determine the contents (e.g., reservation information and message information) of the SCI. In some examples, the first transmission and the at least one retransmission may utilize a vehicle-to-everything (V2X) radio access technology (RAT).

In some examples, the first transmission may utilize a vehicle-to-everything (V2X) radio access technology (RAT). In some examples, the at least one retransmission may utilize a V2X radio RAT.

At block 1208, the first wireless communication device may decode feedback associated with the first transmission when (e.g., if, as a result of, etc.) the signal strength is greater than a threshold or abstain from detecting the feedback when (e.g., if, as a result of, etc.) the signal strength is less than the threshold. For example, the dynamic detection circuitry 1143, together with the communication and processing circuitry 1141 and transceiver 1110, shown and described above in connection with FIG. 11 may determine whether to detect feedback (e.g., for a groupcast transmission by the second wireless communication device) from the at least one third wireless communication device based on a comparison of the signal strength measured at block 1204 with a threshold. In a scenario where the signal strength is greater than a threshold, the dynamic detection circuitry 1143, together with the communication and processing circuitry 1141 and transceiver 1110, may monitor a feedback channel for the feedback. In a scenario where the signal strength is less than the threshold, the dynamic detection circuitry 1143 may skip the monitoring of the feedback channel.

In some examples, the method may further include generating a candidate set of free resources of the plurality of resources. In some examples, the generating the candidate set of free resources may include including in the candidate set of free resources at least one third resource that overlaps with the at least one second resource. In some examples, the at least one third resource is for a communication by the first wireless communication device. In some examples, the generating the candidate set of free resources may include detecting the feedback associated with the first transmission and including in the candidate set of free resources at least one third resource that overlaps with the at least one second resource after detecting the feedback associated with the first transmission.

In some examples, the method may further include determining that the signal strength is less than or equal to the threshold. In some examples, the method may further include including in a candidate set of free resources of the plurality of resources at least one third resource that overlaps with the at least one second resource after determining that the signal strength is less than or equal to the threshold. In some examples, the method may further include abstaining from detecting the feedback after determining that the signal strength is less than or equal to the threshold.

In some examples, the method may further include determining that the signal strength is greater than or equal to the threshold and decoding the feedback after determining that the signal strength is greater than or equal to the threshold.

In some examples, the method may further include determining, based on the decoding of the feedback, that the second wireless communication device will not perform the at least one retransmission. In some examples, the method may further include including in a candidate set of free resources of the plurality of resources at least one third resource that overlaps with the at least one second resource after determining, based on the decoding of the feedback, that the second wireless communication device will not perform the at least one retransmission. In some examples, the determining, based on the decoding of the feedback, that the second wireless communication device will not perform the at least one retransmission may include determining that the first transmission is a first type of groupcast transmission associated with a communication range and determining that none of the at least one third wireless communication device transmitted a negative acknowledgment. In some examples, the determining, based on the decoding of the feedback, that the second wireless communication device will not perform the at least one retransmission may include determining that the first transmission is a second type of groupcast transmission associated with a communication range and determining that each of the at least one third wireless communication device transmitted a positive acknowledgement.

In some examples, the method may further include comparing the signal strength to the threshold. In some examples, the method may further include detecting the feedback after comparing the signal strength to the threshold.

In some examples, the method may further include determining a candidate set of free resources. In some examples, determining the candidate set of free resources may include selecting at least one resource that overlaps with the at least one second resource for a communication by the first wireless communication device. In some examples, determining the candidate set of free resources may include detecting the feedback associated with the first transmission, and determining whether to include in the candidate set of free resources at least one resource that overlaps with the at least one second resource after detecting the feedback associated with the first transmission.

In some examples, the method may further include determining that the signal strength is less than or equal to a threshold. In some examples, the method may further include including in a candidate set of free resources at least one resource that overlaps with the at least one second resource after determining that the signal strength is less than or equal to the threshold. In some examples, the method may further include electing to not detect the feedback after determining that the signal strength is less than or equal to the threshold. In some examples, the signal strength may include a reference signal received power (RSRP).

In some examples, the method may further include determining that the signal strength is greater than or equal to a threshold. In some examples, decoding the feedback may include decoding the feedback after determining that the signal strength is greater than or equal to the threshold.

In some examples, the method may further include determining, based on the decoding of the feedback, whether the second wireless communication device will perform the at least one retransmission. In some examples, the method may further include determining whether to include in a candidate set of free resources at least one resource that overlaps with the at least one second resource after determining, based on the decoding of the feedback, whether the second wireless communication device will perform the at least one retransmission.

In some examples, determining, based on the decoding of the feedback, whether the second wireless communication device will perform the at least one retransmission may include determining that the first transmission may include a first type of groupcast transmission associated with a communication range, and determining whether a negative acknowledgment was transmitted by any one of the at least one third wireless communication device. In some examples, determining, based on the decoding of the feedback, whether the second wireless communication device will perform the at least one retransmission may include determining that the first transmission may include a second type of groupcast transmission associated with a communication range, and determining whether a positive acknowledgment was transmitted by each of the at least one third wireless communication device.

In some examples, the method may further include determining, based on the signal strength, whether to detect the feedback. In some examples, the method may further include determining, based on the signal strength, whether to detect a physical sidelink feedback channel (PSFCH). In some examples, the signal strength may include a reference signal received power (RSRP).

In some examples, determining, based on the signal strength, whether to detect the feedback may include comparing the signal strength to a threshold. In some examples, the threshold may be higher than a signal strength threshold defined for resource exclusion. In some examples, the method may further include defining the threshold based on a traffic load associated with the plurality of resources. In some examples, the method may further include defining the threshold based on channel busy ratio (CBR) associated with the plurality of resources. In some examples, the method may further include defining the threshold so that a defined percentage of the plurality of resources are included in a candidate set of free resources.

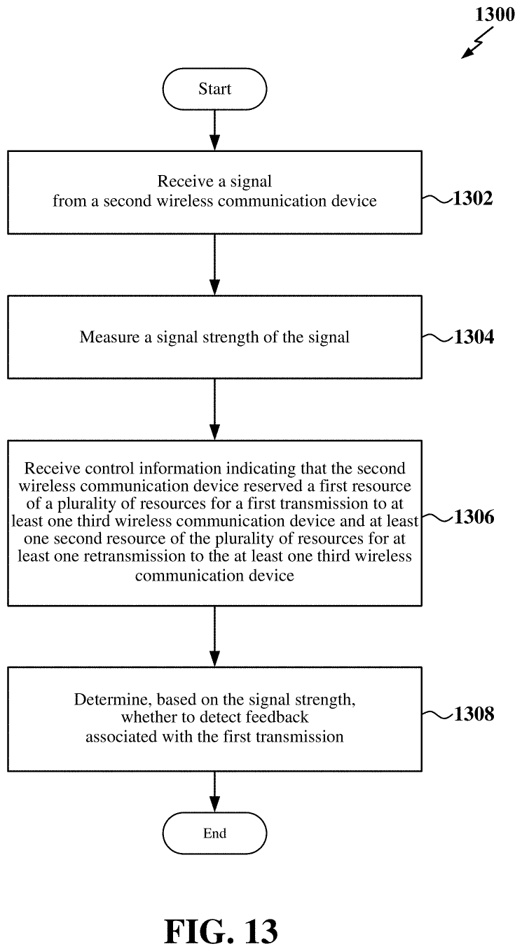

FIG. 13 is a flow chart of a method 1300 for a wireless communication device to determine whether to detect feedback according to some aspects. As described below, some or all illustrated features may be omitted in a particular implementation within the scope of the present disclosure, and some illustrated features may not be required for implementation of all examples. In some examples, the method 1300 may be performed by the wireless communication device 1100, as described above and illustrated in FIG. 11, by a processor or processing system, or by any suitable means for carrying out the described functions.

At block 1302, a first wireless communication device may receive a signal from a second wireless communication device. In some examples, receiving the signal from the second wireless communication device may include receiving the signal via a physical sidelink control channel (PSCCH) or a physical sidelink shared channel (PSSCH). For example, the communication and processing circuitry 1141 and transceiver 1110, shown and described above in connection with FIG. 11, may monitor at least one of PSCCH signaling, PSSCH signaling, other signaling, or a combination thereof, from the second wireless communication device.

At block 1304, the first wireless communication device may measure a signal strength of the signal. For example, the signal processing circuitry 1142 and/or the communication and processing circuitry 1141, shown and described above in connection with FIG. 11, may process the signal received at block 1302 to determine a received signal strength of the signal. In some examples, the signal strength is RSRP.

At block 1306, the first wireless communication device may receive control information (e.g., sidelink control information) indicating that the second wireless communication device reserved a first resource of a plurality of resources for a first transmission to at least one third wireless communication device and at least one second resource of the plurality of resources for at least one retransmission to the at least one third wireless communication device. For example, the resource selection circuitry 1144, together with the communication and processing circuitry 1141 and the transceiver 1110, shown and described above in connection with FIG. 11 may receive an SCI from the second wireless communication device and decode the SCI to determine the contents (e.g., reservation information and message information) of the SCI. In some examples, the first transmission and the at least one retransmission may utilize a vehicle-to-everything (V2X) radio access technology (RAT).

At block 1308, the first wireless communication device may determine, based on the signal strength, whether to detect feedback associated with the first transmission. For example, the dynamic detection circuitry 1143, together with the communication and processing circuitry 1141 and transceiver 1110, shown and described above in connection with FIG. 11 may determine whether to detect feedback (e.g., for a groupcast transmission by the second wireless communication device) from the at least one third wireless communication device.

In some examples, feedback detection may involve detecting a feedback channel. For example, determining, based on the signal strength, whether to detect the feedback may include determining, based on the signal strength, whether to detect a physical sidelink feedback channel (PSFCH).

In some examples, determining, based on the signal strength, whether to detect the feedback may include determining that the signal strength is less than or equal to a threshold and electing to not detect the feedback after determining that the signal strength is less than or equal to the threshold. For example, an election to not detect feedback may be based on whether the signal strength is less than or equal to the threshold. In some examples, the method 1300 may involve including in a candidate set of free resources at least one resource that overlaps with the at least one second resource after determining that the signal strength is less than or equal to the threshold. For example, the resource selection circuitry 1144 shown and described above in connection with FIG. 11 may select resources for the candidate set. In some examples, a decision to schedule a communication may be based on whether the signal strength is less than or equal to the threshold.

In some examples, determining, based on the signal strength, whether to detect the feedback may include determining that the signal strength is greater than or equal to a threshold and decoding the feedback after determining that the signal strength is greater than or equal to the threshold. For example, a decision of whether to detect feedback may be based on whether the signal strength is greater than or equal to the threshold. In some examples, the method 1300 may include determining, based on the decoding of the feedback, whether the second wireless communication device will perform the at least one retransmission and determining whether to include in a candidate set of free resources at least one resource that overlaps with the at least one second resource after determining, based on the decoding of the feedback, whether the second wireless communication device will perform the at least one retransmission. For example, the resource selection circuitry 1144, together with the communication and processing circuitry 1141 and the transceiver 1110, shown and described above in connection with FIG. 11 may process the feedback to determine whether there will be a retransmission (e.g., based on the presence and/or absence of NACKs and/or ACKs) and determine whether to reclaim the at least one second resource accordingly. In some examples, a decision of whether to select a resource for a candidate set may be based on whether the second wireless communication device will perform the at least one retransmission. In some examples, determining, based on the decoding of the feedback, whether the second wireless communication device will perform the at least one retransmission may include determining that the first transmission may include a first type of groupcast transmission associated with a communication range and determining whether a negative acknowledgment was transmitted by any one of the at least one third wireless communication device. In some examples, determining, based on the decoding of the feedback, whether the second wireless communication device will perform the at least one retransmission may include determining that the first transmission may include a second type of groupcast transmission associated with a communication range and determining whether a positive acknowledgment was transmitted by each of the at least one third wireless communication device. In some examples, determining, based on the decoding of the feedback, whether the second wireless communication device will perform the at least one retransmission may include determining whether there is at least one wireless communication device that either sends negative feedback or does not send positive feedback.

In some examples, determining, based on the signal strength, whether to detect the feedback may include comparing the signal strength to a threshold. In some examples, the threshold may be a higher than a signal strength threshold defined for resource exclusion (e.g., a threshold for determining whether to reserve a resource of the plurality of resources). In some examples, the method 1300 may include defining the threshold based on a traffic load associated with the plurality of resources. In some examples, the method 1300 may include defining the threshold based on a channel busy ratio (CBR) associated with the plurality of resources. In some examples, the method 1300 may include defining the threshold so that a defined percentage of the plurality of resources are included in the candidate set of free resources. In some examples, the method 1300 may include defining the threshold so that a defined percentage of the plurality of resources remain free. For example, the resource selection circuitry 1144 shown and described above in connection with FIG. 11 may define (e.g., generate) the threshold.

In some examples, the method 1300 may include determining a candidate set of free resources after determining, based on the signal strength, whether to detect feedback associated with the first transmission. For example, the resource selection circuitry 1146 shown and described above in connection with FIG. 11 may conduct a resource selection operation (e.g., determine at least one resource for the candidate set). In some examples, the resource selection operation may be conducted based on (e.g., as a result of) a decision to detect feedback. In some examples, determining the candidate set of free resources may include selecting at least one resource that overlaps with the at least one second resource for a communication by the first wireless communication device. In some examples, determining the candidate set of free resources may include detecting the feedback associated with the first transmission and determining whether to include in the candidate set of free resource at least one resource that overlaps with the at least one second resource after detecting the feedback associated with the first transmission. For example, a decision to select a resource may be based on detected feedback.

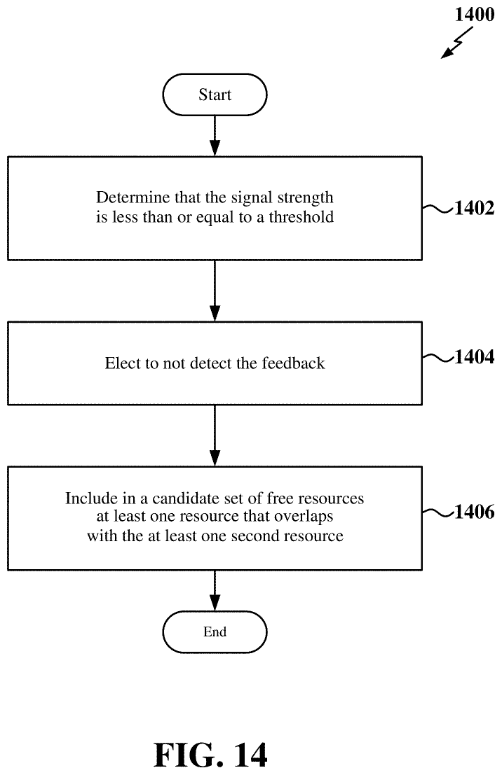

FIG. 14 is a flow chart of a method 1400 for a wireless communication device to determine whether to detect feedback according to some aspects. In some examples, one or more aspects of the method 1400 may be implemented in conjunction with (e.g., as part of and/or in addition to) the method 1200 of FIG. 12 and/or the method 1300 of FIG. 13. As described below, some or all illustrated features may be omitted in a particular implementation within the scope of the present disclosure, and some illustrated features may not be required for implementation of all examples. In some examples, the method 1400 may be performed by the wireless communication device 1100, as described above and illustrated in FIG. 11, by a processor or processing system, or by any suitable means for carrying out the described functions.

At block 1402, a first wireless communication device may determine that the signal strength is less than or equal to a threshold. For example, the signal processing circuitry 1142 and/or the communication and processing circuitry 1141, shown and described above in connection with FIG. 11, may compare the signal strength with a threshold.

At block 1404, the first wireless communication device may elect to not detect the feedback. For example, based on (e.g., as a result of) of the determination of block 1402, the dynamic detection circuitry 1143, shown and described above in connection with FIG. 11, may elect to abstain from decoding any feedback sequences on the PSFCH.

At block 1406, the first wireless communication device may include in a candidate set of free resources at least one resource that overlaps with the at least one second resource. For example, the resource selection circuitry 1146, together with the communication and processing circuitry 1141 and the transceiver 1110, shown and described above in connection with FIG. 11 may, based on (e.g., as a result of) the election of block 1404, update the candidate set. Subsequently, this circuitry may determine whether the first wireless communication device will transmit on the at least one resource and, if so, send an SCI indicating the first wireless communication device's scheduling of the at least one second resource.

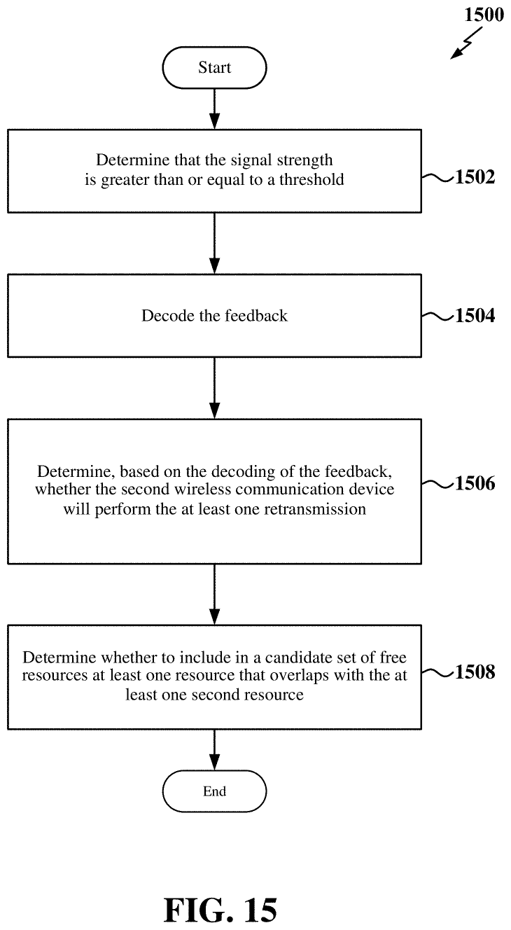

FIG. 15 is a flow chart of a method 1500 for a wireless communication device to determine whether to detect feedback according to some aspects. In some examples, one or more aspects of the method 1500 may be implemented in conjunction with (e.g., as part of and/or in addition to) the method 1200 of FIG. 12 and/or the method 1300 of FIG. 13. As described below, some or all illustrated features may be omitted in a particular implementation within the scope of the present disclosure, and some illustrated features may not be required for implementation of all examples. In some examples, the method 1500 may be performed by the wireless communication device 1100, as described above and illustrated in FIG. 11, by a processor or processing system, or by any suitable means for carrying out the described functions.

At block 1502, a first wireless communication device may determine that the signal strength is greater than or equal to a threshold. For example, the signal processing circuitry 1142 and/or the communication and processing circuitry 1141, shown and described above in connection with FIG. 11, may compare the signal strength with a threshold.

At block 1504, the first wireless communication device may decode the feedback based on (e.g., as a result of) the determining that the signal strength is greater than or equal to the threshold at block 1502. For example, the dynamic detection circuitry 1143 and/or the communication and processing circuitry 1141, shown and described above in connection with FIG. 11, may decode the feedback. In some example, the feedback may be feedback sequences associated with a groupcast message that were received on the PSFCH. In some examples, the feedback may be decoded based on (e.g., as a result of) a determination that the signal strength is greater than or equal to the threshold.

At block 1506, the first wireless communication device may determine whether the second wireless communication device will perform the at least one retransmission. For example, based on the decoding of the feedback at block 1504, the resource selection circuitry 1146, together with the communication and processing circuitry 1141 and the transceiver 1110, shown and described above in connection with FIG. 11 may process the feedback to determine whether any NACKs and/or any ACKs were sent in response to a groupcast message.

At block 1508, the first wireless communication device may determine whether to include in a candidate set of free resources at least one resource that overlaps with the at least one second resource. For example, based on (e.g., as a result of) the determination at block 1506, the resource selection circuitry 1146, together with the communication and processing circuitry 1141 and transceiver 1110, shown and described above in connection with FIG. 11 may determine whether to update the candidate set. For example, if the at least one second resource is free, this circuitry may update the candidate set and, if applicable, send an SCI indicating the first wireless communication device's scheduling of the at least one second resource. Conversely, this circuitry may search for another resource on which to conduct a communication if the at least one second resource is not free.

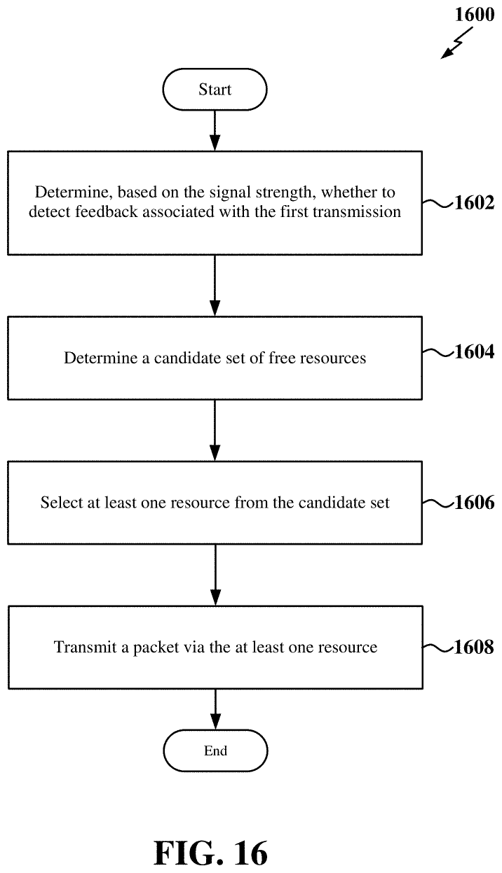

FIG. 16 is a flow chart of a method 1600 for a wireless communication device to determine whether to detect feedback according to some aspects. In some examples, one or more aspects of the method 1600 may be implemented in conjunction with (e.g., as part of and/or in addition to) the method 1200 of FIG. 12 and/or the method 1300 of FIG. 13. As described below, some or all illustrated features may be omitted in a particular implementation within the scope of the present disclosure, and some illustrated features may not be required for implementation of all examples. In some examples, the method 1600 may be performed by the wireless communication device 1100, as described above and illustrated in FIG. 11, by a processor or processing system, or by any suitable means for carrying out the described functions.

At block 1602, a first wireless communication device may determine, based on the signal strength, whether to detect feedback associated with the first transmission. For example, the signal processing circuitry 1142 and/or the communication and processing circuitry 1141, shown and described above in connection with FIG. 11, may compare a measured signal strength with a signal strength threshold.

At block 1604, the first wireless communication device may determine a candidate set of free resources. For example, the dynamic detection circuitry 1143 and/or the communication and processing circuitry 1141, shown and described above in connection with FIG. 11, may include in a candidate set one or more of the resources that overlap with the resources that the second wireless communication device will not be using.

At block 1606, the first wireless communication device may select at least one resource from the candidate set. For example, the resource selection circuitry 1146, shown and described above in connection with FIG. 11, may randomly select a resource from the candidate set of free resources for a transmission by the first wireless communication device.

At block 1608, the first wireless communication device may transmit a packet via the at least one resource selected at block 1606. For example, the communication and processing circuitry 1141 and transceiver 1110, shown and described above in connection with FIG. 11 may transmit a packet to another wireless communication device on the at least one resource selected at block 1606.

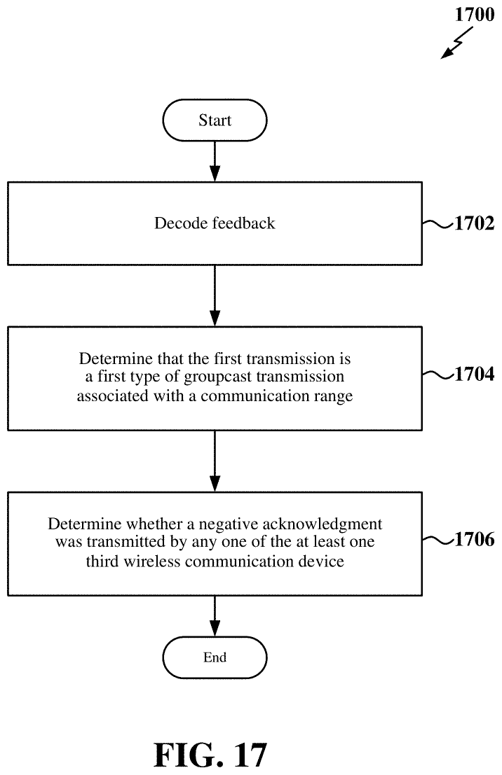

FIG. 17 is a flow chart of a method 1700 for a wireless communication device to determine whether to detect feedback according to some aspects. In some examples, one or more aspects of the method 1700 may be implemented in conjunction with (e.g., as part of and/or in addition to) the method 1200 of FIG. 12 and/or the method 1300 of FIG. 13. As described below, some or all illustrated features may be omitted in a particular implementation within the scope of the present disclosure, and some illustrated features may not be required for implementation of all examples. In some examples, the method 1700 may be performed by the wireless communication device 1100, as described above and illustrated in FIG. 11, by a processor or processing system, or by any suitable means for carrying out the described functions.

At block 1702, a first wireless communication device may decode feedback. For example, the signal processing circuitry 1142 together with the communication and processing circuitry 1141 and transceiver 1110, shown and described above in connection with FIG. 11, may monitor a feedback channel (e.g., a PSFCH). In addition, the signal processing circuitry 1142 may process any signaling received on the channel to recover feedback information transmitted on the feedback channel by at least one third wireless communication device.

At block 1704, the first wireless communication device may determine that the first transmission is a first type of groupcast transmission (e.g., option 1 groupcast) associated with a communication range. For example, the dynamic detection circuitry 1143 together with the communication and processing circuitry 1141 and transceiver 1110, shown and described above in connection with FIG. 11, may determine the type of groupcast scheduled by an SCI that was received from a second wireless communication device. In some examples, the second wireless communication device may indicate the groupcast type in control information transmitted by the second wireless communication device (e.g., on a PSCCH).

At block 1706, the first wireless communication device may determine whether a negative acknowledgment was transmitted by any one of the at least one third wireless communication device. For example, the dynamic detection circuitry 1143, shown and described above in connection with FIG. 11, may determine whether any of the feedback decoded at block 1702 constitutes a NACK.

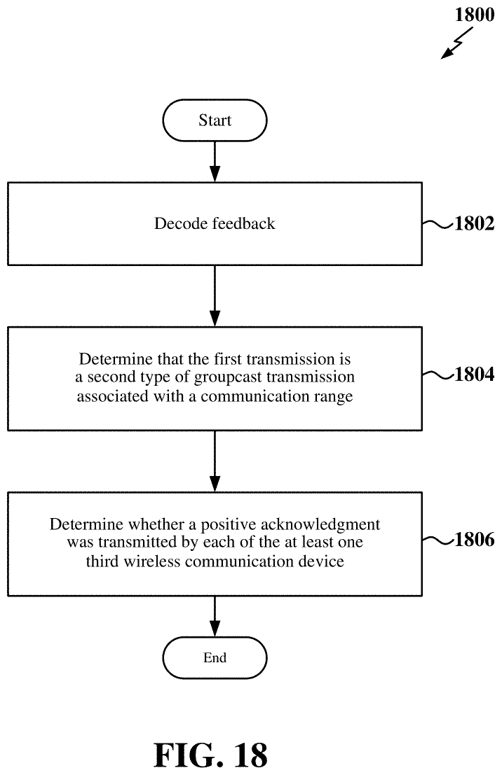

FIG. 18 is a flow chart of a method 1800 for a wireless communication device to determine whether to detect feedback according to some aspects. In some examples, one or more aspects of the method 1800 may be implemented in conjunction with (e.g., as part of and/or in addition to) the method 1200 of FIG. 12 and/or the method 1300 of FIG. 13. As described below, some or all illustrated features may be omitted in a particular implementation within the scope of the present disclosure, and some illustrated features may not be required for implementation of all examples. In some examples, the method 1800 may be performed by the wireless communication device 1100, as described above and illustrated in FIG. 11, by a processor or processing system, or by any suitable means for carrying out the described functions.

At block 1802, a first wireless communication device may decode feedback. For example, the signal processing circuitry 1142 together with the communication and processing circuitry 1141 and transceiver 1110, shown and described above in connection with FIG. 11, may monitor a feedback channel (e.g., a PSFCH). In addition, the signal processing circuitry 1142 may process any signaling received on the channel to recover feedback information transmitted on the feedback channel by at least one third wireless communication device.

At block 1804, the first wireless communication device may determine that the first transmission is a second type of groupcast transmission (e.g., option 2 groupcast) associated with a communication range. For example, the dynamic detection circuitry 1143 together with the communication and processing circuitry 1141 and transceiver 1110, shown and described above in connection with FIG. 11, may determine the type of groupcast scheduled by an SCI that was received from a second wireless communication device. In some examples, the second wireless communication device may indicate the groupcast type in control information transmitted by the second wireless communication device (e.g., on a PSCCH).

At block 1806, the first wireless communication device may determine whether a positive acknowledgment was transmitted by each of the at least one third wireless communication device. For example, the dynamic detection circuitry 1143, shown and described above in connection with FIG. 11, may determine whether all of the feedback decoded at block 1802 constitutes an ACK.

The following provides an overview of several aspects of the present disclosure.

Aspect 1: A method for wireless communication at a first wireless communication device, the method comprising: receiving a signal from a second wireless communication device; measuring a signal strength of the signal; receiving control information indicating that the second wireless communication device reserved a first resource of a plurality of resources for a first transmission to at least one third wireless communication device and at least one second resource of the plurality of resources for at least one retransmission to the at least one third wireless communication device; and decoding feedback associated with the first transmission when the signal strength is greater than a threshold or abstaining from detecting the feedback when the signal strength is less than the threshold.

Aspect 2: The method of aspect 1, further comprising: generating a candidate set of free resources of the plurality of resources.

Aspect 3: The method of aspect 2, wherein the generating the candidate set of free resources comprises: including in the candidate set of free resources at least one third resource that overlaps with the at least one second resource, wherein the at least one third resource is for a communication by the first wireless communication device.

Aspect 4: The method of any of aspects 2 through 3, wherein the generating the candidate set of free resources comprises: detecting the feedback associated with the first transmission; and including in the candidate set of free resources at least one third resource that overlaps with the at least one second resource after detecting the feedback associated with the first transmission.

Aspect 5: The method of any of aspects 1 through 4, further comprising: determining that the signal strength is less than or equal to the threshold; and including in a candidate set of free resources of the plurality of resources at least one third resource that overlaps with the at least one second resource after determining that the signal strength is less than or equal to the threshold.

Aspect 6: The method of aspect 5, further comprising: abstaining from detecting the feedback after determining that the signal strength is less than or equal to the threshold.

Aspect 7: The method of any of aspects 1 through 6, wherein the signal strength comprises a reference signal received power (RSRP).

Aspect 8: The method of any of aspects 1 through 7, further comprising: determining that the signal strength is greater than or equal to the threshold; and decoding the feedback after determining that the signal strength is greater than or equal to the threshold.

Aspect 9: The method of aspect 8, further comprising: determining, based on the decoding of the feedback, that the second wireless communication device will not perform the at least one retransmission; and including in a candidate set of free resources of the plurality of resources at least one third resource that overlaps with the at least one second resource after determining, based on the decoding of the feedback, that the second wireless communication device will not perform the at least one retransmission.

Aspect 10: The method of aspect 9, wherein the determining, based on the decoding of the feedback, that the second wireless communication device will not perform the at least one retransmission comprises: determining that the first transmission comprises a first type of groupcast transmission associated with a communication range; and determining that none of the at least one third wireless communication device transmitted a negative acknowledgment.

Aspect 11: The method of any of aspects 9 through 10, wherein the determining, based on the decoding of the feedback, whether the second wireless communication device will not perform the at least one retransmission comprises: determining that the first transmission comprises a second type of groupcast transmission associated with a communication range; and determining that each of the at least one third wireless communication device transmitted a positive acknowledgement.

Aspect 12: The method of any of aspects 1 through 11, further comprising: comparing the signal strength to the threshold.

Aspect 13: The method of aspect 12, further comprising: detecting the feedback after comparing the signal strength to the threshold.

Aspect 14: The method of any of aspects 1 through 13, wherein the receiving the signal from the second wireless communication device comprises: receiving the signal via a physical sidelink control channel (PSCCH) or a physical sidelink shared channel (PSSCH).

Aspect 15: The method of aspect 1, wherein the threshold is higher than a signal strength threshold defined for resource exclusion.

Aspect 16: The method of any of aspects 1 through 15, further comprising: defining the threshold based on a traffic load associated with the plurality of resources.

Aspect 17: The method of any of aspects 1 through 16, further comprising: defining the threshold based on channel busy ratio (CBR) associated with the plurality of resources.

Aspect 18: The method of any of aspects 1 through 17, further comprising: defining the threshold so that a defined percentage of the plurality of resources are included in a candidate set of free resources of the plurality of resources.

Aspect 19: The method of any of aspects 1 through 18, further comprising:

detecting a physical sidelink feedback channel (PSFCH) when the signal strength is greater than the threshold.

Aspect 20: The method of any of aspects 1 through 19, further comprising: receiving the signal via a physical sidelink control channel (PSCCH) or a physical sidelink shared channel (PSSCH).

Aspect 21: The method of any of aspects 1 through 20, wherein the first transmission and the at least one retransmission utilize a vehicle-to-everything (V2X) radio access technology (RAT).

Aspect 22: A wireless communication device comprising: a transceiver configured to communicate with a radio access network, a memory, and a processor communicatively coupled to the transceiver and the memory, wherein the processor and the memory are configured to perform any one of aspects 1 through 21.

Aspect 23: An apparatus configured for wireless communication comprising at least one means for performing any one of aspects 1 through 21.

Aspect 24: A non-transitory computer-readable medium storing computer-executable code, comprising code for causing an apparatus to perform any one of aspects 1 through 21.

Several aspects of a wireless communication network have been presented with reference to an example implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-18 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 3, 7, 8, 9, and 11 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communication at a first wireless communication device, the method comprising:
receiving a signal from a second wireless communication device;
measuring a signal strength of the signal;
receiving control information indicating that the second wireless communication device reserved a first resource of a plurality of resources for a first transmission to at least one third wireless communication device and at least one second resource of the plurality of resources for at least one retransmission to the at least one third wireless communication device; and
decoding feedback associated with the first transmission when the signal strength is greater than a threshold or abstaining from detecting the feedback when the signal strength is less than the threshold.

2. The method of claim 1, further comprising:
generating a candidate set of free resources of the plurality of resources.

3. The method of claim 2, wherein the generating the candidate set of free resources comprises:
including in the candidate set of free resources at least one third resource that overlaps with the at least one second resource, wherein the at least one third resource is for a communication by the first wireless communication device.

4. The method of claim 2, wherein the generating the candidate set of free resources comprises:
detecting the feedback associated with the first transmission; and
including in the candidate set of free resources at least one third resource that overlaps with the at least one second resource after detecting the feedback associated with the first transmission.

5. The method of claim 1, further comprising:
determining that the signal strength is less than or equal to the threshold; and
including in a candidate set of free resources of the plurality of resources at least one third resource that overlaps with the at least one second resource after determining that the signal strength is less than or equal to the threshold.

6. The method of claim 5, further comprising:
abstaining from detecting the feedback after determining that the signal strength is less than or equal to the threshold.

7. The method of claim 1, wherein the signal strength comprises a reference signal received power (RSRP).

8. The method of claim 1, further comprising:
determining that the signal strength is greater than or equal to the threshold; and
decoding the feedback after determining that the signal strength is greater than or equal to the threshold.

9. The method of claim 8, further comprising:
determining, based on the decoding of the feedback, that the second wireless communication device will not perform the at least one retransmission; and
including in a candidate set of free resources of the plurality of resources at least one third resource that overlaps with the at least one second resource after determining, based on the decoding of the feedback, that the second wireless communication device will not perform the at least one retransmission.

10. The method of claim 9, wherein the determining, based on the decoding of the feedback, that the second wireless communication device will not perform the at least one retransmission comprises:
determining that the first transmission comprises a first type of groupcast transmission associated with a communication range; and
determining that none of the at least one third wireless communication device transmitted a negative acknowledgment.

11. The method of claim 9, wherein the determining, based on the decoding of the feedback, whether the second wireless communication device will not perform the at least one retransmission comprises:
determining that the first transmission comprises a second type of groupcast transmission associated with a communication range; and
determining that each of the at least one third wireless communication device transmitted a positive acknowledgement.

12. The method of claim 1, further comprising:
comparing the signal strength to the threshold.

13. The method of claim 12, further comprising:
detecting the feedback after comparing the signal strength to the threshold.

14. The method of claim 1, wherein the receiving the signal from the second wireless communication device comprises:
receiving the signal via a physical sidelink control channel (PSCCH) or a physical sidelink shared channel (PSSCH).

15. A first wireless communication device, comprising:
a transceiver;
a memory; and
a processor communicatively coupled to the transceiver and the memory, wherein the processor and the memory are configured to:
receive a signal from a second wireless communication device via the transceiver;
measure a signal strength of the signal;
receive, via the transceiver, control information indicating that the second wireless communication device reserved a first resource of a plurality of resources for a first transmission to at least one third wireless communication device and at least one second resource of the plurality of resources for at least one retransmission to the at least one third wireless communication device; and
decode feedback associated with the first transmission when the signal strength is greater than a threshold or abstain from detecting the feedback when the signal strength is less than the threshold.

16. The first wireless communication device of claim 15, wherein the processor and the memory are further configured to:
generate a candidate set of free resources of the plurality of resources.

17. The first wireless communication device of claim 16, wherein the processor and the memory are further configured to:
include in the candidate set of free resources at least one third resource that overlaps with the at least one second resource, wherein the at least one third resource is for a communication by the first wireless communication device.

18. The first wireless communication device of claim 16, wherein the processor and the memory are further configured to:
detect the feedback associated with the first transmission; and
include in the candidate set of free resources of the plurality of resources at least one third resource that overlaps with the at least one second resource after detecting the feedback associated with the first transmission.

19. The first wireless communication device of claim 15, wherein the processor and the memory are further configured to:
compare the signal strength to the threshold.

20. The first wireless communication device of claim 19, wherein the processor and the memory are further configured to:
detect the feedback after comparing the signal strength to the threshold.

21. The first wireless communication device of claim 19, wherein the signal strength comprises a reference signal received power (RSRP).

22. The first wireless communication device of claim 15, wherein the threshold is higher than a signal strength threshold defined for resource exclusion.

23. The first wireless communication device of claim 15, wherein the processor and the memory are further configured to:
define the threshold based on a traffic load associated with the plurality of resources.

24. The first wireless communication device of claim 15, wherein the processor and the memory are further configured to:
define the threshold based on channel busy ratio (CBR) associated with the plurality of resources.

25. The first wireless communication device of claim 15, wherein the processor and the memory are further configured to:
define the threshold so that a defined percentage of the plurality of resources are included in a candidate set of free resources of the plurality of resources.

26. The first wireless communication device of claim 15, wherein the processor and the memory are further configured to:
detect a physical sidelink feedback channel (PSFCH) when the signal strength is greater than the threshold.

27. The first wireless communication device of claim 15, wherein the processor and the memory are further configured to:
receive the signal via a physical sidelink control channel (PSCCH) or a physical sidelink shared channel (PSSCH).

28. The first wireless communication device of claim 15, wherein the first transmission and the at least one retransmission utilize a vehicle-to-everything (V2X) radio access technology (RAT).

29. A first wireless communication device, comprising:
means for receiving a signal from a second wireless communication device;
means for measuring a signal strength of the signal;
means for receiving control information indicating that the second wireless communication device reserved a first resource of a plurality of resources for a first transmission to at least one third wireless communication device and at least one second resource of the plurality of resources for at least one retransmission to the at least one third wireless communication device; and
means for decoding feedback associated with the first transmission when the signal strength is greater than a threshold or abstaining from detecting the feedback when the signal strength is less than the threshold.

30. An article of manufacture for use by a first wireless communication device in a wireless communication network, the article comprising:
a non-transitory computer-readable medium having stored therein instructions executable by one or more processors of the first wireless communication device to:
receive a signal from a second wireless communication device;
measure a signal strength of the signal;
receive control information indicating that the second wireless communication device reserved a first resource of a plurality of resources for a first transmission to at least one third wireless communication device and at least one second resource of the plurality of resources for at least one retransmission to the at least one third wireless communication device; and
decode feedback associated with the first transmission when the signal strength is greater than a threshold or abstain from detecting the feedback when the signal strength is less than the threshold.
